(19) United States
(12) Patent Application Publication
(10) Pub. No.: US 2026/0204100 A1
(43) Pub. Date: Jul. 16, 2026

(54) JOINT SENSOR-CLOUD-BASED FALL DETECTION BASED ON LARGE VISION-LANGUAGE MODEL WITH MINIMAL FALSE ALARMS AND MISSED DETECTIONS

(71) Applicant: AltumView Systems Inc., Burnaby (CA)

(72) Inventors: Andrew Tsun-Hong Au, Coquitlam (CA); Jie Liang, Coquitlam (CA); Jiannan Zheng, Delta (CA)

(73) Assignee: AltumView Systems Inc., Burnaby (CA)

(21) Appl. No.: 19/561,521

(22) Filed: Mar. 10, 2026

Related U.S. Application Data
(63) Continuation-in-part of application No. 19/090,388, filed on Mar. 25, 2025.
Application No. 19/090,388 is a continuation of application No. 17/522,901, filed on Nov. 9, 2021, now Pat. No. 12,260,677.
(60) Provisional application No. 63/111,621, filed on Nov. 9, 2020.

(51) Int. Cl. G06V 40/20; G06F 21/62; G06T 13/40; G06V 20/40; G06V 40/16

(52) U.S. Cl. CPC G06V 40/23; G06F 21/6245; G06T 13/40; G06V 20/41; G06V 40/166

(57) ABSTRACT

In one aspect, a process of detecting personal falls is disclosed. This process may begin at a local vision sensor, which captures a video of a monitored space including a monitored person. A first fall detection model on the vision sensor is then used to process the captured video to detect a fall of the monitored person. Next, in response to detecting a fall of the monitored person, the local vision sensor transmits a raw image of the monitored space and a fall alert to a server. Next, the raw image of the monitored space and the associated fall alert is received by the server. A second fall detection model on the server is used to process the raw image to detect a fall of the monitored person. In response to determining that no fall has occurred of the monitored person, the server disregards the received fall alert, thereby reducing false alarms.

### PRIORITY CLAIM AND RELATED PATENT APPLICATIONS

This patent application is a continuation-in-part of, and hereby claims the benefit of priority under 35 U.S.C. § 120 to co-pending U.S. patent application Ser. No. 19/090,388, filed on 25 Mar. 2025 (Attorney Docket No. AVS 020.US03CIP1), entitled, “PRIVACY-PRESERVING HIGH-SENSITIVITY FALL DETECTION USING JOINT VISION SENSOR AND CLOUD COMPUTING,” by inventors Andrew Tsun-Hong Au et al., which in turn claims the benefit of priority under 35 U.S.C. § 120 to U.S. patent application Ser. No. 17/522,901, filed on 9 Nov. 2021 (Attorney Docket No. AVS020.US01), entitled, “PRIVACY-PRESERVING HUMAN ACTION RECOGNITION, STORAGE, AND RETRIEVAL VIA JOINT EDGE AND CLOUD COMPUTING,” by inventors Chi Chung Chan et al., which in turn claims the benefit of priority under 35 U.S.C. 119(e) to U.S. Provisional Ser. No. 63/111,621 , entitled “Skeleton-Based Low-Cost Structured Human Action Data Recording, Storage, Retrieval, and Inference,” by the same inventors, and filed on filed on 9 Nov. 2020 (Attorney Docket No. AVS 020.PRV01), all of the above-listed applications are incorporated herein by reference as a part of this patent document.

### TECHNICAL FIELD

The disclosed embodiments generally relate to the field of human activity, health, and wellness monitoring. More specifically, the disclosed embodiments relate to devices, systems and techniques for performing privacy-preserving human-activity data collection, recognition, transmission, storage and retrieval by combining local pre-processing at the data source and remote post-processing at a cloud server.

### BACKGROUND

Video-based human action recognition refers to the technology of automatically analyzing human actions based on captured videos and video images of a single person or a group of people. For example, one particularly useful application of video-based human action recognition is for monitoring health and wellness of individuals based on video images captured by surveillance video cameras. However, one problem associated with traditional video surveillance technologies is that they cannot protect the privacy of the users, e.g., if the recorded surveillance videos stored in a local or remote server are accessed by hackers. As a result, traditional surveillance cameras are usually used to monitor outdoor/public areas, while being prohibited for use in private areas such as bedrooms and bathrooms. However, sometimes it may be necessary to monitor these private areas, e.g., to detect emergency events of seniors such as personal falls, especially those who live alone. It may also become necessary to use cameras in such private settings for doctors to remotely observe the activities of patients with certain diseases, such as dementia, Parkinson's, and depression.

Another problem associated with traditional video surveillance technologies is that processing and storing the recorded videos often require a huge amount of transmission bandwidth and storage space. Note that the flexibility and ability to analyze the recorded video content at a later time to detect and determine temporal and spatial events, persons and objects in the recorded videos are required by many applications. However, to allow future video content retrieval and analysis, the recorded videos often need to be first transmitted to a remote server and then stored in the cloud. Typically, a one-hour 360 p recorded video will need 450 megabytes (MB) of storage space, a 24-hour 360 p recorded video will need ~10.8 gigabytes (GB) of storage space, and one month of such low-resolution recorded videos will need 324 GB of storage space. If such videos are stored on the Amazon AWS cloud server, the unit cost would be $0.023/GB/month, so that the monthly cost for one-month 360 p videos storage would be about $7.452. However, the storage cost will be much higher for higher resolution videos. As a result, existing home surveillance cameras cannot save too many videos in the cloud for too long. A typical approach is to store the motion-triggered video clips or continuous video records in the cloud temporarily for a few days up to one month, and a user needs to pay a monthly fee ranging from $1.49 to $30 per camera.

Hence, what is needed is a recorded video transmission, storage, and retrieval technique without the drawbacks of existing techniques.

### SUMMARY

In this patent disclosure, various embodiments of a video-based privacy-preserving fall-detection system that performs joint fall-detection operations using both a local vision sensor and a cloud server to minimize both false alarms and missed detections of a standalone local vision sensor for fall detection are disclosed. In one aspect, a process of automatically detecting personal falls through video monitoring on behalf of a user is disclosed. This process may begin at a local vision sensor, which captures a video of a monitored space including at least one monitored person. Further at local vision sensor, a first fall detection model is used to process one or more video frames of the video to detect a fall of the at least one monitored person. Next, in response to detecting a fall of the at least one monitored person, the local vision sensor transmits a raw image of the monitored space and a fall alert to a server. Next, at the server, the raw image of the monitored space and the associated fall alert is received from the local vision sensor. Further at the server, a second fall detection model is used to process the raw image to detect a fall of the at least one monitored person. Next, in response to determining that no fall has occurred of the at least one monitored person, the server identifies the received fall alert from the local vision sensor as a false alarm and subsequently disregards the received fall alert, thereby reducing a number of false alarms.

In some embodiments, the first fall detection model includes a first deep-learning model configured to detect a fall based on recognizing a set of predetermined human actions.

In some embodiments, the local vision sensor includes an embedded artificial intelligence (AI) processor for executing the deep-learning-based fall detection model, wherein the embedded AI processor is associated with limited computational resources.

In some embodiments, the process further includes the steps of processing each of the one or more video frames of the video by: (1) extracting at least one skeleton-figure representation of the at least one monitored person, wherein the at least one skeleton-figure representation does not include personal identifiable information (PII) of the at least one monitored person; and (2) applying the first deep-learning model on the at least one skeleton-figure representation to detect a fall of the at least one monitored person.

In some embodiments, prior to transmitting the raw image of the monitored space, the process further includes obtaining the raw image by capturing a real-time image of the monitored space.

In some embodiments, transmitting the raw image of the monitored space includes transmitting an encrypted version of the raw image from the local vision sensor to the server.

In some embodiments, the second fall detection model includes a large vision-language model (VLM) configured to detect a fall of the detected person by processing the received raw image.

In some embodiments, prior to processing the raw image using the second fall detection model, the process further includes training the large VLM using a training dataset constructed to accommodate as many types of true fall scenarios as possible.

In some embodiments, the server is a cloud-based server that includes significantly higher computational resources than those of the local vision sensor, and the VLM residing on the server has significantly higher accuracies in detecting various types of falls of the at least one monitored person than the accuracies of the first fall detection model residing on the local vision sensor.

In some embodiments, the process further includes the step of, in response to determining that a fall has occurred based on the raw image by the second fall detection model, sending a fall alert to a mobile device of the user indicating the at least one monitored person has fallen.

In another aspect, a system that automatically detects personal falls through video monitoring on behalf of a user is disclosed. This system includes both a local vision sensor and a server. The local vision sensor further includes: one or more cameras configured to capture a video of a monitored space including at least one monitored person; a first set of processors; and a first memory coupled to the one or more cameras and the first set of processors. The first memory further stores instructions that, when executed by the first set of processors, cause the local vision sensor to: (1) process one or more video frames of the video using a first fall detection model to detect a fall of the at least one monitored person; and (2) in response to detecting a fall of the at least one monitored person, transmit a raw image of the monitored space and a fall alert to the server. The server further includes a second set of processors and a second memory coupled to the second set of processors. The second memory further stores instructions that, when executed by the second set of processors, cause the server to: (1) receive the raw image of the monitored space and the associated fall alert from the local vision sensor; (2) process the raw image using a second fall detection model to detect a fall of the at least one monitored person; and (3) in response to determining that no fall has occurred of the at least one monitored person, identify the received fall alert from the local vision sensor as a false alarm and disregard the received fall alert, thereby reducing a number of false alarms.

In some embodiments, the second memory further stores instructions that, when executed by the second set of processors, cause the server to, in response to determining that a fall has occurred of the at least one monitored person, send a fall alert to a mobile device of the user indicating the at least one monitored person has fallen.

In some embodiments, the first fall detection model includes a first deep-learning model configured to detect a fall based on recognizing a set of predetermined human actions.

In some embodiments, the first set of processors includes an embedded artificial intelligence (AI) processor for executing the deep-learning-based fall detection model, wherein the embedded AI processor is associated with limited computational resources.

In some embodiments, the first memory further stores instructions that, when executed by the first set of processors, cause the local vision sensor to: (1) extract at least one skeleton-figure representation of the at least one monitored person, wherein the at least one skeleton-figure representation does not include personal identifiable information (PII) of the at least one monitored person; and (2) apply the first deep-learning model on the at least one skeleton-figure representation to detect a fall of the at least one monitored person.

In some embodiments, the first memory further stores instructions that, when executed by the first set of processors, cause the local vision sensor to: (1) obtain the raw image by capturing a real-time image of the monitored space; and (2) transmit an encrypted version of the raw image to the server.

In some embodiments, the second fall detection model includes a large vision-language model (VLM) configured to detect a fall of the detected person by processing the received raw image.

In some embodiments, prior to processing the raw image using the second fall detection model, the large VLM is trained using a training dataset constructed to accommodate as many types of true fall scenarios as possible.

In some embodiments, the server is a cloud-based server that includes significantly higher computational resources than those of the local vision sensor, and the VLM residing on the server has significantly higher accuracies in detecting various types of falls of the at least one monitored person than fall detection accuracies of the first fall detection model residing on the local vision sensor.

In yet another aspect, a process of detecting personal falls through video monitoring on behalf of a user is disclosed. This process may begin at a local vision sensor, which captures a video of a monitored space including at least one monitored person. Further at local vision sensor, a first fall detection model is used to process one or more video frames of the video to detect a fall of the at least one monitored person. Next, in response to determining that no fall has occurred of the at least one monitored person, the local vision sensor further determines if a set of predefined conditions is met. If so, the local vision sensor transmits a raw image of the monitored space and a non-fall decision to a server. Next, at the server, the raw image of the monitored space and the associated non-fall decision is received from the local vision sensor. Further at the server, a second fall detection model is used to process the raw image to detect a fall of the at least one monitored person. Next, in response to detecting a fall of the at least one monitored person by the second fall detection model, the server identifies the received non-fall decision from the local vision sensor as a missed fall detection and subsequently sends a fall alert to a mobile device of the user indicating the at least one monitored person has fallen, thereby mitigating the missed fall detection.

In some embodiments, the set of predefined conditions includes: (1) the at least one monitored person is detected at a location within a floor area of the monitored space; (2) the at least one monitored person has remained at the detected location for at least a predefined time threshold T; and (3) no fall alert has been sent by the local vision sensor from the detected location.

In some embodiments, the predefined time threshold T is determined to be the minimum time required to call the second fall detection model on the server to verify the non-fall decision by the local vision sensor.

In some embodiments, the predefined time threshold T is determined to be the maximum wait time before calling the second fall detection model on the server to verify a non-fall decision to ensure the safety of the at least one monitored person in case of a missed fall detection by the local vision sensor.

In some embodiments, in response to determining that the set of predefined conditions is not met, the process proceeds to executing other tasks without transmitting a raw image of the monitored space and a non-fall decision to the server. In doing so, unnecessary calls to the second fall detection model on the server are significantly reduced when non-fall decisions are made by the local vision sensor, which significantly reduces computational costs.

In some embodiments, the first fall detection model includes a first deep-learning model configured to detect a fall of the at least one detected person based on recognizing a set of predetermined human actions.

In some embodiments, the second fall detection model includes a large vision-language model (VLM) configured to detect a fall of the at least one detected person by processing the received raw image, wherein the VLM has significantly higher accuracies in detecting various types of falls of the at least one monitored person than fall detection accuracies of the first deep-learning model.

In some embodiments, the local vision sensor includes an embedded artificial intelligence (AI) processor for executing the first deep-learning model, wherein the embedded AI processor is associated with limited computational resources.

In some embodiments, the server is a cloud-based server that includes one or more graphic processing units (GPUs), wherein the cloud-based server includes significantly higher computational power and storage space than those of the local vision sensor.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates a block diagram of a disclosed joint human-action recognition system including at least one local vision sensor and a cloud-based server in accordance with some embodiments described herein.

FIG. 2 shows a block diagram of the deep-learning subsystem of the disclosed local vision sensor within the disclosed joint human-action recognition system in accordance with some embodiments described herein.

FIG. 3 shows an exemplary skeleton figure of a detected person generated by the pose estimation module using 18 keypoints to represent a human body in accordance with some embodiments described herein.

FIG. 4 shows a block diagram of the disclosed cloud server of the disclosed joint human-action recognition system in accordance with some embodiments described herein.

FIGS. 5A-5C show an exemplary reconstruction and playback application of a skeleton sequence of a detected person in front of a common background image in accordance with some embodiments described herein.

FIG. 6 presents a flowchart illustrating an exemplary process for performing real-time human-action recognition using the disclosed joint human-action recognition system in accordance with some embodiments described herein.

FIG. 7A illustrates an image depicting an exemplary true fall event.

FIG. 7B illustrates an image depicting an exemplary event of a person who is sleeping on the floor but with a posture almost identical to a fall.

FIG. 7C illustrates an image depicting an extracted skeleton figure of a detected person in the image that appears to have fallen in accordance with some embodiments described herein.

FIG. 7D illustrates an image depicting an extracted skeleton figure of a detected person in the image that does not appear to have fallen in accordance with some embodiments described herein.

FIG. 8 present a flowchart illustrating a process of detecting personal falls while reducing false alarms by jointly operating a local vision sensor and a cloud server in accordance with some embodiments described herein.

FIG. 9 present a flowchart illustrating a process of detection personal falls while simultaneously reducing false alarms and missed detections by jointly operating a local vision sensor and a cloud server in accordance with some embodiments described herein.

FIG. 10 illustrates an exemplary hardware environment for the disclosed local vision sensor in the disclosed joint human-action recognition system in accordance with some embodiments described herein.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Using disclosed joint human-action recognition system 100, sanitized/de-identified human-action data can be generated locally and transmitted to cloud server in place of the raw video images to preserve the privacy of each monitored person. This real-time human-action data has a very small data size and hence requires very little network bandwidth. Next, complex action recognition tasks can be performed in the cloud in real-time based on the received privacy-preserving real-time human-action data.

Because the transmitted skeleton sequences 212 of the detected persons and the background image do not include any personal identifiable information (PII), the privacy of the detected persons is preserved and protected in the disclosed joint human-action recognition system 100. Moreover, transmitting skeleton sequences instead of the actual video images requires a significantly lower network bandwidth.

Note that the generated skeleton sequence 212 can replace the actual images of the detected person in the raw video frames 230 for transmission, storage, and further action-recognition on cloud server 104. By transmitting the extracted skeleton sequences instead of transmitting the actual video images, the disclosed joint human-action recognition system 100 achieves a significantly lower network bandwidth requirement. Moreover, by storing the skeleton sequences of the detected persons instead of storing actual person images, the disclosed joint human-action recognition system 100 achieves a significantly reduced storage requirement and cost on cloud server 104. Furthermore, by using the preprocessed skeleton sequences of the detected persons to perform complex action recognition on cloud server 104 instead of using the raw person images, the disclosed joint human-action recognition system 100 achieves a significantly faster action recognition speed on cloud server 104.

### Terminology

Throughout this patent disclosure, the terms “human action” and “human activity” are used interchangeably to mean a continuous motion of a person which can be captured by a sequence of video frames in a video. Moreover, the term a “video frame” refers to a single frame of video image/still image within a captured video.

### Proposed Joint Human Action Recognition System Overview

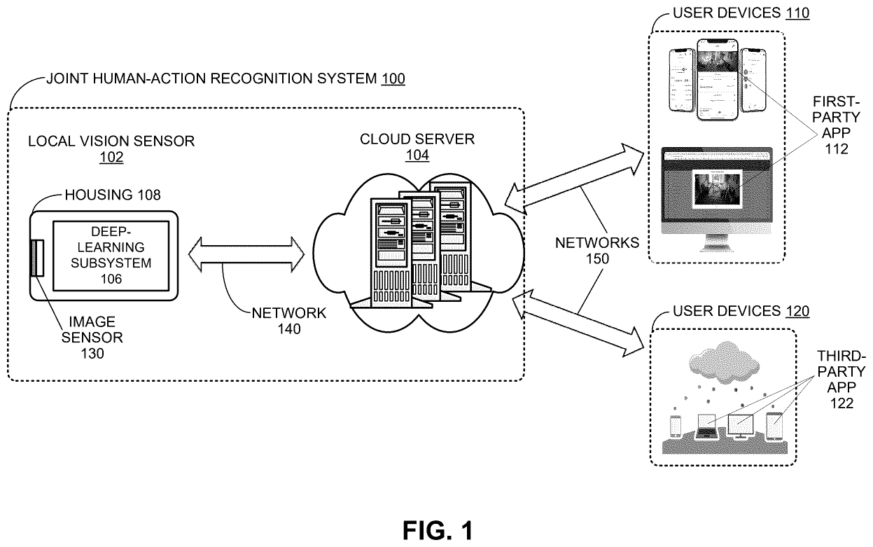

FIG. 1 illustrates a block diagram of a disclosed joint human-action recognition system 100 including at least one local vision sensor 102 and a cloud-based server 104 in accordance with some embodiments described herein. As can be seen in FIG. 1, joint human-action recognition system 100 includes at least one local vision sensor 102. However, the disclosed joint human-action recognition system can generally include any number of local vision sensors. Generally speaking, local vision sensor 102 is an intelligent vision system (which is sometimes referred to as an “intelligent camera” or “smart camera”) that includes a built-in image sensor (e.g., a charge-coupled device (CCD) or a complementary metal-oxide- semiconductor (CMOS) camera), one or more processors for performing specific image processing on the images captured by the build-in image sensor, and a housing 108 that encapsulates the image sensor and the processors. Local vision sensor 102 can be installed or otherwise located at a place where certain human actions/activities of one or more persons need to be monitored. For example, local vision sensor 102 can be installed at an assisted living facility, a nursing care home, or a private home, and the one or more persons being monitored can be elderly people living in the assisted living facility, the nursing care home, or the private home.

In some embodiments, local vision sensor 102 can include a image sensor 130 (e.g., a CCD or a CMOS camera) for capturing raw videos of a space or an area that can include one or more persons being monitored, and a deep learning-based image-processing subsystem 106 (or “deep-learning subsystem 106”) that includes both hardware processors and software modules for processing the captured videos and video frames. More specifically, the disclosed deep-learning subsystem 106 is configured to process captured video frames locally and in real-time to detect one or more monitored persons in the captured video frames, and to extract also in real-time, skeleton figures and as a result, skeleton sequences for the one or more detected persons from the captured video frames. In some embodiments, deep-learning subsystem 106 includes functionalities to remove, replace, or otherwise de-identify each detected person in a given video frame after extracting the corresponding skeleton figures/skeleton sequences of the detected person from the captured video frames. For example, deep-learning subsystem 106 can replace the processed video frames with the corresponding extracted skeleton sequences and a common background image to be stored locally. In some embodiments, the raw video frames that have been processed by deep-learning subsystem 106 can be permanently deleted.

In some embodiments, deep-learning subsystem 106 is configured to separately capture (e.g., before capturing the video frames) a background image of the monitored space/area without any person in the image. After a video of the monitored space/area is captured, deep-learning subsystem 106 is used to extract the skeleton sequences of one or more detected persons from the captured video frames. Next, the extracted skeleton sequences can be transmitted to cloud-based server 104 (or “cloud server 104” hereinafter) along with the background image. Because the transmitted skeleton sequences of the detected persons and the background image do not include any personal identifiable information (PII), the privacy of the detected persons is preserved and protected. Note that this background image associated with the captured video frames only needs to be transmitted to cloud server 104 once, until the background image is updated on local vision sensor 102. Hence, at a later time, the recorded scene/action sequences in the captured video frames can be reconstructed on cloud server 104 by overlaying the extracted one or more skeleton sequences onto the background image to form a new and sanitized video clip.

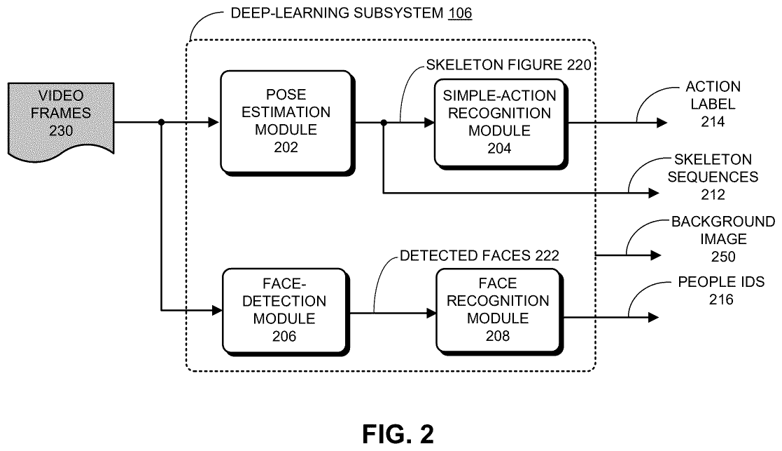

Note that local vision sensor 102 generally has limited computational resources, including limited computational power and storage space. In some embodiments, local vision sensor 102 can perform some simple action recognition functions using either the raw video frames or the extracted skeleton sequences. These simple action recognition functions can include, but are not limited to: recognition of standing, sitting down, lying down, falling, and waving hand. However, local vision sensor 102 is generally not designed to and hence not used to perform more complex action/activity recognitions, especially those actions that need long-time data, such as eating, cooking, quality of service of care workers, or diagnosis of certain behavioral diseases such as dementia, Parkinson's, and depression. By not performing the above complex action recognition functions, local vision sensor 102 can utilize its limited computational power and storage space to extract skeleton sequences for one or more detected persons in real-time, and transmit the extracted skeleton sequences in real-time to cloud server 104. As such, more complex action recognitions can be performed in real-time or offline on the cloud server based on the received skeleton sequences from local vision sensor 102. Local vision sensor 102 is described in more detail below in conjunction with FIG. 2.

Note that local vision sensor 102 is coupled to cloud server 104 through a network 140. Local vision sensor 102 configured to transmit real-time sanitized/de-identified human-action data including the skeleton sequences of the detected people to cloud server 104. Note that this real-time human-action data has a very small data size and hence requires very little network bandwidth for transmission. Cloud server 104 is configured to receive real-time sanitized/de-identified human-action data including the above-described skeleton sequences of the detected people from local vision sensor 102. Cloud server 104 is further configured to re-organize the received skeleton sequences, including indexing the received skeleton sequences based on one or more data attributes. These data attributes that can be used to index the received skeleton sequences can include, but are not limited to: people IDs, camera IDs, group IDs (e.g., people that belong to different monitoring groups), and recording timestamps. For example, cloud server 104 can be configured to re-organize the received skeleton sequences based on different people IDs that are used to differentiate skeleton sequences of different people. Cloud server 104 is further configured to store the indexed/structured skeleton sequences into an indexing database which can be efficiently searched, queried, and post-processed by an external user application (or “App”) or by an internal data-processing module such as a complex action recognition module described below. Note that the received skeleton sequences can also be stored un-indexed or semi-indexed on a mass storage on cloud-based server 104. As described below, storing skeleton sequences in place of raw video images provides an extremely low-cost and privacy-preserving option for users who have need to store many hours of the recorded human action data temporarily or permanently.

Cloud server 104 is additionally configured to perform real-time or offline action recognition based on the received skeleton sequences. For real-time action recognition, cloud server 104 can directly receive real-time skeleton sequences from local vision sensor 102, process the received skeleton sequences to generate complex action/activity predictions using deep-learning techniques and big-data analytics. Because cloud server 104 includes significantly higher computational resources and storage space than local vision sensor 102, cloud server 104 is able to comfortably process the real-time skeleton sequences using high-complexity deep-learning algorithms and big-data analytics for any number of detected people and generate real-time human action/activity predictions based on the real-time skeleton sequences. Consequently, local vision sensor 102 and cloud server 104 operate collectively and concurrently to achieve privacy-preserving complex human action recognitions for multiple detected people in real-time. Alternatively, for offline action recognition, cloud server 104 can retrieve stored indexed skeleton sequences from an indexing database on cloud server 104, process the indexed skeleton sequences to generate human action predictions that require long-term data.

Referring back to FIG. 1, note that the disclosed joint human-action recognition system 100 can be coupled to various user devices through various networks 150. More specifically, the disclosed joint human-action recognition system 100 can be coupled to a first set of user devices 110 which run the first-party video-monitoring App 112 developed in conjunction with the disclosed joint human-action recognition system 100. Note that first-party video-monitoring App 112 can include a mobile version running on mobile devices and a web version running on desktop devices. Moreover, the disclosed joint human-action recognition system 100 can also be coupled to a second set of user devices 120 which run various third-party Apps 122 that can access the stored skeleton sequences on cloud server 104 of the disclosed joint human-action recognition system 100. Note that third-party video-monitoring Apps can also include third-party mobile Apps running on mobile devices and third party web-Apps running on desktop devices.

FIG. 2 shows a block diagram of the deep-learning subsystem 106 of the disclosed local vision sensor 102 within the disclosed joint human-action recognition system 100 in accordance with some embodiments described herein. As can be seen in FIG. 2, deep-learning subsystem 106 can include: a pose-estimation module 202, a simple-action recognition module 204, a face-detection module 206, and a face-recognition module 208, each of the modules 202-208 performs specific deep-learning-based image processing computations. In some embodiments, deep-learning subsystem 106 can be implemented by one or more artificial intelligent (AI) processors. Note that other embodiments of deep-learning subsystem 106 of the disclosed local vision sensor 102 can include additional functional modules or omit one or more of the functional modules shown in FIG. 2 without departing from the scope of the present disclosure. For example, some embodiments of the disclosed local vision sensor 102 can also include a scene-segmentation/object-recognition module for detecting non-human objects in the recorded video frames.

In the embodiment shown, deep-learning subsystem 106 receives a sequence of video frames 230 as input. In some embodiments, the sequence of video frames 230 is a video segment of a predetermined duration within a recorded video. Note that video frames 230 are also referred as raw video images/frames because they are the output of image sensor 130 and have not yet been processed. Deep-learning subsystem 106 is configured to perform various deep-learning-based video image processing tasks on video frames 230 including, but are not limited to: (1) detecting each person and extracting skeleton figures and skeleton sequences from the sequence of video frames 230 using pose estimation module 202; (2) estimating some simple human actions for each extracted skeleton figure using simple-action recognition module 204; (3) detecting faces from video frames 230 using face-detection module 206; and (4) performing face recognitions on the detected faces using face-recognition module 208. In some embodiments, simple-action recognition module 204 also includes functionalities to identify certain emergency events, such as a fall, based on the estimated simple-human-actions, and subsequently generating emergency alarms/alerts.

In some embodiments, pose estimation module 202 is configured to process the sequence of video frames 230 to detect each and every person captured in each video image/frame of the sequence of video frames 230. Specifically, pose estimation module 202 is configured to detect each person within each image/frame of the sequence of video frame 230 and generate a set of keypoints of human body (also referred to as “human keypoints” or simply “keypoints” hereinafter) of the detected person. For example, the set of keypoints of the human body can include the eyes, the nose, the ears, the chest, the shoulders, the elbows, the wrists, the knees, the hip joints, and the ankles of the detected person. More specifically, each generated keypoint in the set of keypoints can be represented by either a two-dimensional (2D) location (i.e., a set of X-and Y-coordinates in a 2D plane), or a three-dimensional (3D) location (i.e., a set of X-, Y-, and Z-coordinates in a 3D space), as well as a probability value for the predicted body joint associated with the generated keypoint.

Note that each set of keypoints extracted from a single video frame form a keypoint-skeleton representation of the detected person in the given video frame. In the discussion below, we refer to the set of human keypoints identified and extracted from a detected person image within a single video frame as the “skeleton figure” or the “skeleton representation” of the detected person in the given video frame. We further refer to a sequence of such skeleton figures extracted from a sequence of video frames as a “skeleton sequence” of the detected person. Hence, after processing the sequence of video frames 230, pose estimation module 202 outputs one or more skeleton sequences 212 of one or more detected persons in the sequence of video frames 230, wherein each skeleton sequence further comprises a sequence of individual skeleton figures of a particular detected person.

More detail of pose estimation module 202 is described in U.S. patent application Ser. No. 16/672,432, filed on 2 Nov. 2019 and entitled “METHOD AND SYSTEM FOR PRIVACY-PRESERVING FALL DETECTION,” (Attorney Docket No. AVS010.US01), the content of which is incorporated herein by reference.

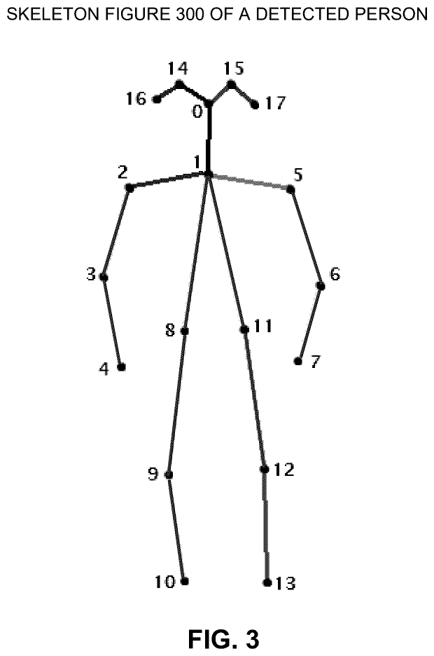

FIG. 3 shows an exemplary skeleton FIG. 300 of a detected person generated by pose estimation module 202 using 18 keypoints to represent a human body in accordance with some embodiments described herein. However, other embodiments of pose estimation module 202 can use fewer or greater than 18 keypoints to represent a human body. For example, instead of using the illustrated 18 keypoints, another embodiment of pose estimation module 202 can use just the head, the shoulders, the arms, and the legs of the detected person to represent a human body, which is a subset of the 18-keypoint representation. Yet another embodiment of pose estimation module 202 can use significantly more than the illustrated 18 keypoints of the detected person to represent a human body. Note that even when a predetermined number of keypoints is used by pose estimation module 202 for skeleton-figure extraction, the actual number of the detected keypoints of each extracted skeleton figure of each detected person can change from one video frame to the next video frame. This is because a part of a body of a detected person can be blocked by another object, another person, or by another part of the same body in some video frames, while no blocking of the body in some other video frames.

Moreover, a sequence of skeleton figures of a particular detected person extracted from the sequence of video frames 230 forms a “skeleton sequence” of the detected person, which represents a continuous motion of the detected person. Note that based on an extracted skeleton sequence of a detected person, the action of the detected person can be predicted. In the disclosed joint human-action recognition system 100, if this action-recognition operation is determined to be too difficult for the local vision sensor 102 (e.g., measured by the inference speed and accuracy), this action-recognition operation can be implemented and performed at cloud server 104. In this case, local vision sensor 102/deep-learning subsystem 106 simply outputs one or more extracted skeleton sequences 212 for one or more detected persons in video frames 230, wherein each extracted skeleton sequence 212 for each detected person further includes a sequence of extracted skeleton figures of the detected person. As described above, each extracted skeleton figure in skeleton sequences 212 is composed of a set of extracted keypoints. In some embodiments, each extracted keypoint in the set of extract keypoints is defined by either a set of 2D X and Y-coordinates in a 2D plane, or a set of 3D X-, Y-, and Z-coordinates in a 3D space, as well as a probability value for the predicted body joint of that keypoint.

In some embodiments, one or more extracted skeleton sequences 212 of one or more detected persons from the sequence of video frames 230 can be buffered for a predetermined time interval (e.g., between 10 seconds to a few minutes) without immediate transmission to cloud server 104. Note that each buffered skeleton sequence can include one or more sequences of human actions performed by each detected person during the predetermined time interval. Next, at the end of the predetermined time interval, the entire buffered skeleton sequence(s) can be transmitted from local vision sensor 102 to cloud server 104 through a network 140. This buffered technique can reduce the access cost to the cloud server.

In some embodiments, simple-action recognition module 204 in deep-learning subsystem 106 is configured to receive an extracted skeleton FIG. 220 of a detected person in a given video frame 230, perform a deep-learning-based action recognition based on the configuration of skeleton FIG. 220 and/or localizations of the associated set of keypoints, and subsequently generate an action label 214. Note that this action label 214 represents a predicted pose or simple action for the detected person in the given video frame. As described above, the types of simple actions that can be predicated by simple-action recognition module 204 can include standing, sitting down, lying down, a fall, and waving hand. In some embodiments, action label 214 can be combined with the corresponding extracted skeleton FIG. 220 as a part of the corresponding skeleton sequence 212 output. More detail of simple-action recognition module 204 is described in U.S. patent application Ser. No. 16/672,432, filed on 2 Nov. 2019 and entitled “METHOD AND SYSTEM FOR PRIVACY-PRESERVING FALL DETECTION,” (Attorney Docket No. AVS010.US01), the content of which is incorporated herein by reference.

Referring back to FIG. 2, note that deep-learning subsystem 106 in local vision sensor 102 also includes face-detection module 206 configured to receive video frames 230 and output detected faces 222 corresponding to the detected persons by pose estimation module 202. Deep-learning subsystem 106 additionally includes face-recognition module 208 configured to perform face recognition functions based on the detected faces 222 from face-detection module 206, and subsequently generate people IDs 216 that correspond to and differentiate different detected persons by pose estimation module 202. In some embodiments, each person ID 216 within people IDs 216 can be combined with the corresponding extracted skeleton FIG. 220 as a part of the corresponding skeleton sequence 212 output. More detail of face-detection module 206 and face-recognition module 208 is described in U.S. patent application Ser. No. 16/672,432, filed on 2 Nov. 2019 and entitled “METHOD AND SYSTEM FOR PRIVACY-PRESERVING FALL DETECTION,” (Attorney Docket No. AVS010.US01), the content of which is incorporated herein by reference.

Note that the generated skeleton sequence 212 can replace the actual images of the detected person in the raw video frames 230 for transmission, storage, and further action-recognition on cloud server 104. By transmitting the extracted skeleton sequences instead of transmitting the actual video images, the disclosed joint human-action recognition system 100 achieves a significantly lower network bandwidth requirement. Moreover, by storing the skeleton sequences of the detected persons instead of storing actual person images, the disclosed joint human-action recognition system 100 achieves a significantly reduced storage requirement and cost on cloud server 104. Furthermore, by using the preprocessed skeleton sequences of the detected persons to perform complex action recognition on cloud server 104 instead of using the raw person images, the disclosed joint human-action recognition system 100 achieves a significantly faster action recognition speed on cloud server 104.

As described above, deep-learning subsystem 106 is configured to separately capture (e.g., before capturing raw video frames 230) a background image 250 of the monitored space/area without any person in the image. After raw video frames 230 are captured, deep-learning subsystem 106 is used to extract the skeleton sequences 212 of one or more detected persons from raw video frames 230. Next, the extracted skeleton sequences 212 can be transmitted to cloud server 104 along with the associated background image 250. Note that this background image 250 only needs to be transmitted to cloud server 104 once, until the background image 250 is updated on local vision sensor 102. Because the transmitted skeleton sequences 212 of the detected persons and the associated background image 250 do not include any PII, the privacy of the detected persons is preserved and protected in the disclosed joint human-action recognition system 100. Note that at a later time, the recorded scene/action sequences in the captured video frames can be reconstructed on cloud server 104 by overlaying the extracted one or more skeleton sequences onto the background image in each reconstructed video frame to form a new video clip.

Note that while the joint human-action recognition system 100 of FIG. 1 shows a single local vision sensor 102, the disclosed joint human-action recognition system can generally include multiple local vision sensors that are all coupled to cloud server 104 through a network. Moreover, these multiple local vision sensors operate independently to capture raw video data and perform the above-described raw-video-data pre-processing to extract respective skeleton sequences of detected people from the respective raw video data in the respective monitoring location/area. The multiple sources/channels of the skeleton sequences and the respective background images of the respective monitoring locations/areas are subsequently transmitted to and received by cloud server 104. Because each vision sensor in the multiple local vision sensors includes a separate camera for capturing separate raw video data, a given channel of the skeleton sequences generated by a given vision sensor in the multiple local vision sensors can be differentiated from other channels of skeleton sequences by a unique camera ID of the camera on the given vision sensor or a unique group ID associated with a different group of people being monitored at a unique location/area.

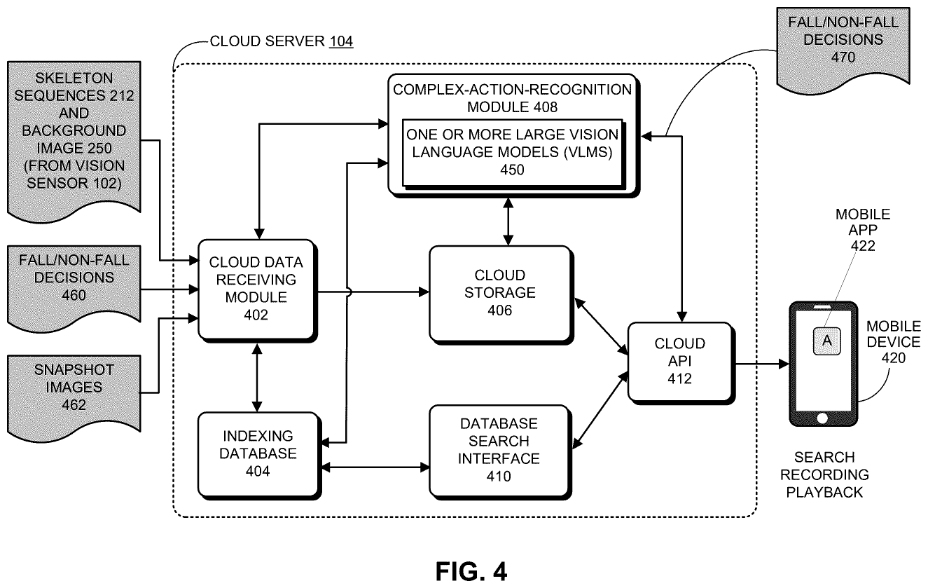

FIG. 4 shows a block diagram of disclosed cloud server 104 within the disclosed joint human-action recognition system 100 in accordance with some embodiments described herein. As can be seen in FIG. 4, cloud server 104 can include: a cloud-data receiving module 402, an indexing database 404, a cloud storage 406, a complex-action-recognition module 408, a database search interface 410, and a cloud Application Programming Interface (API) 412. More specifically, cloud-data receiving module 402 of cloud server 104 receives pre-processed privacy-preserving skeleton sequences 212 from local vision sensor 102 and the associated background image 250 as input. In some embodiments, cloud-data receiving module 402 is further configured to re-organize the received skeleton sequences 212, including indexing the received skeleton sequences 212 based on one or more data attributes. These data attributes that can be used to index the received skeleton sequences 212 can include, but are not limited to: action labels 214, people IDs 216, camera IDs (for embodiments of multiple local vision sensors), group IDs (e.g., people that belong to different monitoring groups), and recording timestamps. For example, cloud-data receiving module 402 can re-organize the received skeleton sequences 212 based on different people IDs, different group IDs, and/or different camera IDs. After data indexing, cloud-data receiving module 402 is configured to store the indexing tables and pointers of the skeleton-sequence data into indexing database 404 for advanced searches, queries, data processing by an external user App or by an internal data-processing module such as complex-action-recognition module 408. Note that storing indexing tables and pointers of the received skeleton sequences 212 into indexing database 404 allows for fast searching and queries without the need to scan the entire skeleton-sequence database.

In some embodiments, in addition to storing the indexed skeleton sequences into indexing database 404, cloud-data receiving module 402 is also configured to store originally-received skeleton sequences 212 and the associated background image 250 into cloud storage 406 without any modification. In some embodiments, the non-modified skeleton sequences are stored in cloud storage 406 encrypted. Moreover, the stored skeleton-sequence data can be separated in cloud storage 406 by the camera IDs, group IDs, people IDs, and record timestamps. In some embodiments, cloud storage 406 is implemented as a mass storage. Note that storing extracted skeleton-sequences data in place of raw video images provides an extremely low-cost and privacy-preserving option for users who have need to store many hours of the recorded human action data temporarily or permanently.

In some embodiments, database search interface 410 in cloud server 104 is configured to process search requests to indexing database 404 from external user devices, such as a search request generated by a mobile App 420 installed on a mobile device 422. More specifically, database search interface 410 is configured to process search requests from mobile App 422 through Cloud API 412, and the processed requests are used to query the stored indexed-skeleton-sequence data in indexing database 404. In some embodiments, when the search request has been processed, only the stored skeleton-sequence data starting from the requested timestamp in the query request is retrieved from cloud stage 406 and sent to the mobile App 420 through cloud API 412 for playback. In this manner, data transfer costs can be significantly reduced.

Using the disclosed joint human-action recognition system 100, sanitized/de-identified skeleton sequences 212 can be generated locally on the local vision sensor 102 and transmitted to cloud server 104 in place of the raw video images to preserve the privacy of each monitored person. In some embodiments, complex-action-recognition module 408 in cloud server 104 is configured to perform either real-time or offline complex action recognition based on the received skeleton sequences 212. In some embodiments, for real-time action recognition, complex-action-recognition module 408 can directly receive real-time skeleton sequences 212 from cloud-data receiving module 402, and subsequently process the received skeleton sequences 212 to generate complex action/activity predictions using deep-learning techniques and big-data analytics. These complex actions/activities can include, but are not limited to: eating, cooking, quality of service of care workers, or diagnosis of certain behavioral diseases such as dementia, Parkinson's, and depression. Because cloud server 104 includes significantly higher computational resources and storage space than local vision sensor 102, complex-action-recognition module 408 on cloud server 104 is able to comfortably process real-time skeleton sequences 212 using high-complexity deep-learning algorithms and big-data analytics for any number of detected people and generate real-time human action/activity predictions based on the real-time skeleton sequences 212. Consequently, local vision sensor 102 and cloud server 102 operate collectively and concurrently to achieve privacy-preserving complex human action recognitions for multiple detected people in real-time.

Alternatively, complex-action-recognition module 408 can be configured to perform offline complex action recognition that requires long-term data from received skeleton-sequence data 212. More specifically, complex-action-recognition module 408 can retrieve stored indexed skeleton sequences from indexing database 404 and cloud storage 406 at a later time based on an external action recognition request from mobile App 422. Complex-action-recognition module 408 subsequently processes the retrieved skeleton sequences from indexing database 404 to generate complex action/activities predictions.

In some embodiments, the disclosed joint human-action recognition system 100 is configured to play back a skeleton sequence stored on cloud server 104 associated with a detected person from a raw video. As described above, this extracted and stored skeleton sequence represents a continuous human motion corresponding to a sequence of video frames or an entire recorded video. In some embodiments, the skeleton sequence playback request can be issued by mobile App 422 on mobile device 420. More specifically, the playback request can specify a person ID and a starting timestamp for a stored skeleton sequence of a particular person identified by the person ID. The playback request can also specify a camera ID and a starting timestamp for the stored skeleton sequences of all persons captured by the particular local vision sensor. The playback request can also specify a time-duration for the playback, so that a precise portion of the stored skeleton sequences can be retrieved from the cloud storage. In some embodiments, to reconstruct a video segment, the retrieved skeleton sequence can be overlaid onto a corresponding identical background image in each reconstructed video frame. Note that this skeleton-sequence-playback function of the disclosed joint human-action recognition system 100 creates a motion animation of the extracted skeleton figures of the detected person, which allows for visualizing and recognizing the action and/or behavior of the person without showing actual body and face of the detected person. Note that, during the skeleton-sequence playback, the name of the detected person can be displayed alongside the animation sequence to differentiate different detected people and difference displayed skeleton sequences.

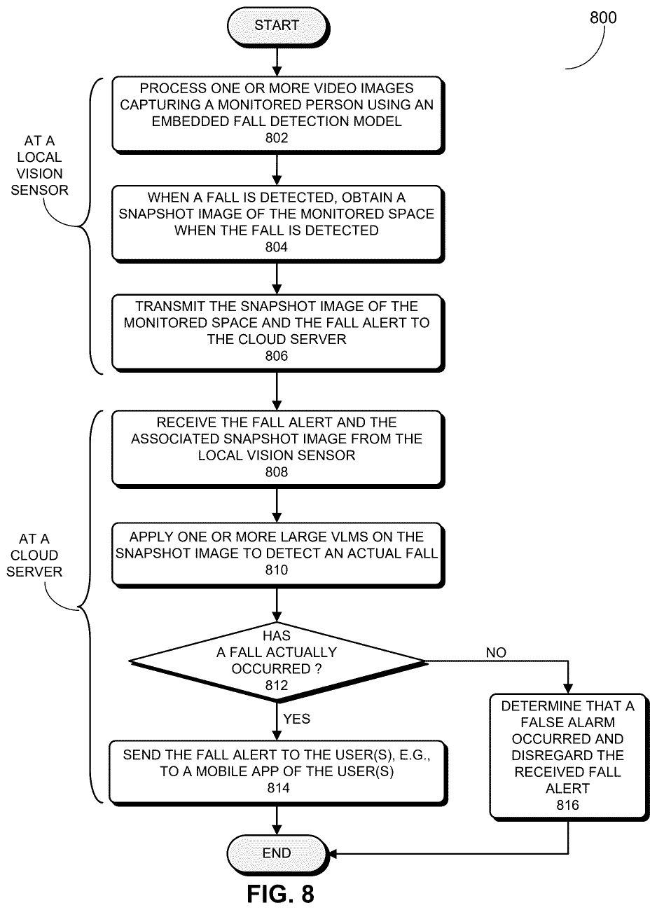

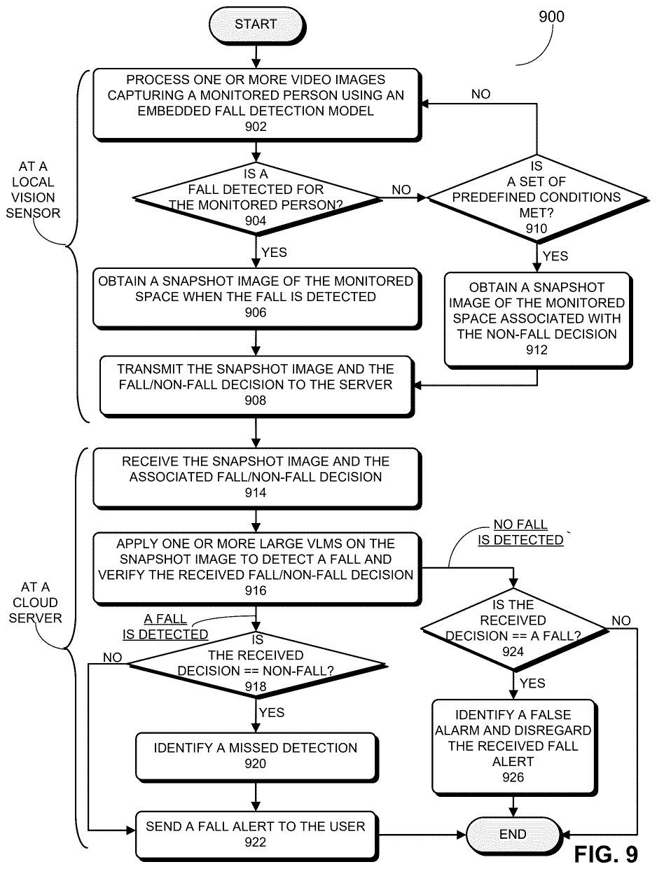

In some embodiments, complex-action-recognition module 408 further includes one or more large vision language models (VLMs) 450. Operating in tandem with local vision sensor 102, complex-action-recognition module 408 on cloud server 104 is configured to receive both a snapshot image 462 of a monitored space and an associated fall/non-fall decision 460 from local vision sensor 102. The one or more large VLMs 450 within complex-action-recognition module 408 are configured to perform personal fall detections on the received snapshot image 462 and subsequently generate an independent fall/non-fall decision 470 for the snapshot image 462. Next, complex-action-recognition module 408 can be configured to verify the received associated fall/non-fall decision 460 from local vision sensor 102 against the fall/non-fall decision 470 generated by the one or more large VLMs 450. Note that the one or more large VLMs 450 running on cloud server 104 have been trained with large and diverse training datasets to accurately detect various forms of true falls in captured video images and are running on expensive AI chips such as high-power, high-performance GPUs within cloud server 104. As a result, the one or more large VLMs 450 have significantly higher capability and accuracy to detect various forms of true falls than local vision sensor 102. In this manner, the one or more large VLMs 450 running on cloud server 104 can verify the fall/non-fall decisions generated by local vision sensor 102 and as a result, identify both false (fall) alarms and missed (fall) detections made by local vision sensor 102, thereby improving the fall-detection sensitivity and true fall-detection rate of joint human-action recognition system 100. More detailed embodiments of joint fall-detection operations of the local vision sensor 102 and the one or more large VLMs 450 running on cloud server 104 are described below, including the embodiments described below in conjunction with FIGS. 8-9. Note that complex-action-recognition module 408 is coupled to cloud API 412. In some embodiments, a fall alert/alarm based on a generated fall decision 470 by the one or more large VLMs 450 can be sent to mobile App 422 on mobile device 420 through Cloud API 412.

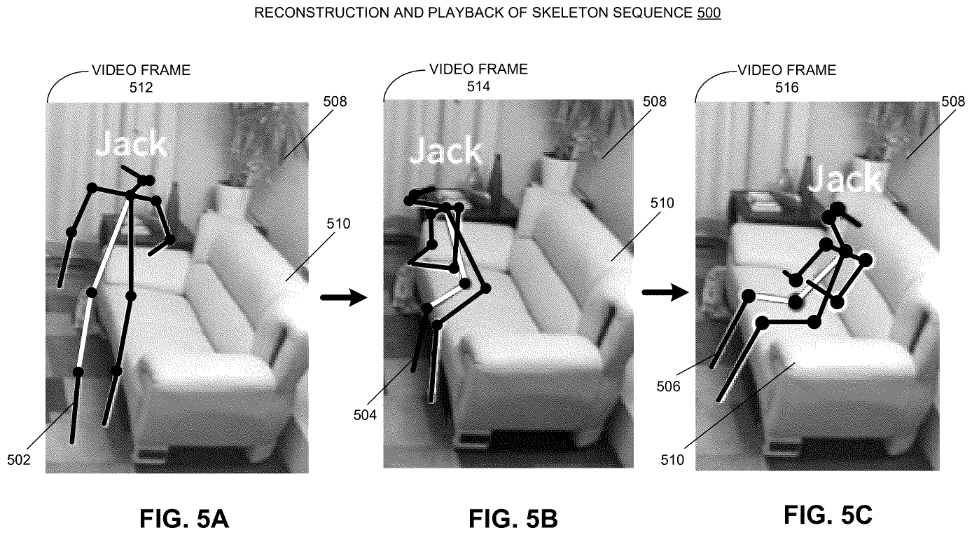

FIGS. 5A-5C show an exemplary reconstruction and playback application of a skeleton sequence 500 of a detected person “Jack” in front of a common background image 508 in accordance with some embodiments described herein. Note that each of the figures FIG. 5A, FIG. 5B, and FIG. 5C includes an extracted skeleton FIGS. 502, 504, and 506, respectively of the same person in a different pose, corresponding to an action/pose at a particular timestamp within a continuous sequence of movements. The sequence of skeleton FIGS. 502, 504, and 506 forms the skeleton sequence 500. Moreover, each of FIGS. 5A-5C also includes an identical background image 508 including a sofa 510. The skeleton sequence 500 combined with background image 508 form a sequence of reconstructed video frames 512, 514, and 516 which can be played back. As described above, the sequence of video frames 512, 514, and 516 corresponding to the skeleton sequence 500 be reconstructed by simply overlaying each skeleton FIG. 502-506 onto the static background image 508 (which can be separately recorded/caputured and stored) at the exact location where the corresponding skeleton figure was originally identified and extracted.

In the exemplary reconstructed skeleton sequence 500, a continuous sequence of movements of a person from standing in front sofa 510 to sitting down on sofa 510 is displayed using the corresponding skeleton figures without showing actual face or even the actual body of the person, thereby fully preserving and protecting the privacy of the person. Instead, the person associated with the skeleton sequence 500 can be identified with a labeled/person ID as such “Jack,” indicating all three skeleton FIGS. 502, 504, and 506 belong to the same person. More specifically, the exemplary skeleton sequence 500 begins with “Jack” standing in front of sofa 510 in FIG. 5A, which is followed by “Jack” in a crouching/squatting pose over sofa 510 in FIG. 5B, and finally when “Jack” in a fully-sitting-down pose on sofa 510 in FIG. 5C. Note that although the three skeleton FIGS. 502-506 in exemplary skeleton sequence 500 are all labeled with the same name/person ID, they may also have different names/person IDs if these skeleton figures do not belong to the same person. Hence, the displayed name/person ID to each skeleton figure is highly important to differentiate different people when all face images are removed. Note that although exemplary skeleton sequence 500 includes only three reconstructed video frames, other embodiments of a skeleton sequence showing the same or a similar sequence of movements can include significantly more intermediate skeleton figures/frames between video frame 512 and video 514.

In some embodiments, the disclosed joint human-action recognition system 100 is configured to use the extracted skeleton figures and/or a skeleton sequence of a detected person in different video frames to detect some complex actions, such as eating, cooking, or detect some behavioral diseases, such as Parkinson's disease, dementia, and depression. Note that these functions can be performed by complex-action-recognition module 408 within the cloud server 104 of the disclosed joint human-action recognition system 100 to generate alarms/alerts or notifications.

In some embodiments, the disclosed joint human-action recognition system 100 is configured to perform face detection of each detected person in the input video frames 230, and label a detected person with an associated personal ID if the face is recognized in a face database of the disclosed local visual sensor 102 (not shown). Note that these face-detection and recognition functions can be performed by face detection module 206 and face recognition module 208 within deep-learning subsystem 106 of local vision sensor 102 of the disclosed joint human-action recognition system 100, which includes generating and output people IDs 216.

In some embodiments, the disclosed joint human-action recognition system 100 is further configured to extract important subimages from the input video frames 230, such as the face of a detected person, or a part/entire body of a detected person, which can be useful for some applications, such as surveillance. Note that these functions can be performed by face detection module 206 within deep-learning subsystem 106 of local vision sensor 102 to generate extracted face subimages and by pose estimation module 202 within deep-learning subsystem 106 of local vision sensor 102 to generate and output extracted human body subimages. In some embodiments, the extracted face subimages and extracted human body subimages can also be transmitted to cloud server 104 for storage and post-processing, for example, to investigate the identities of strangers that are not recognized by the local vision sensor.

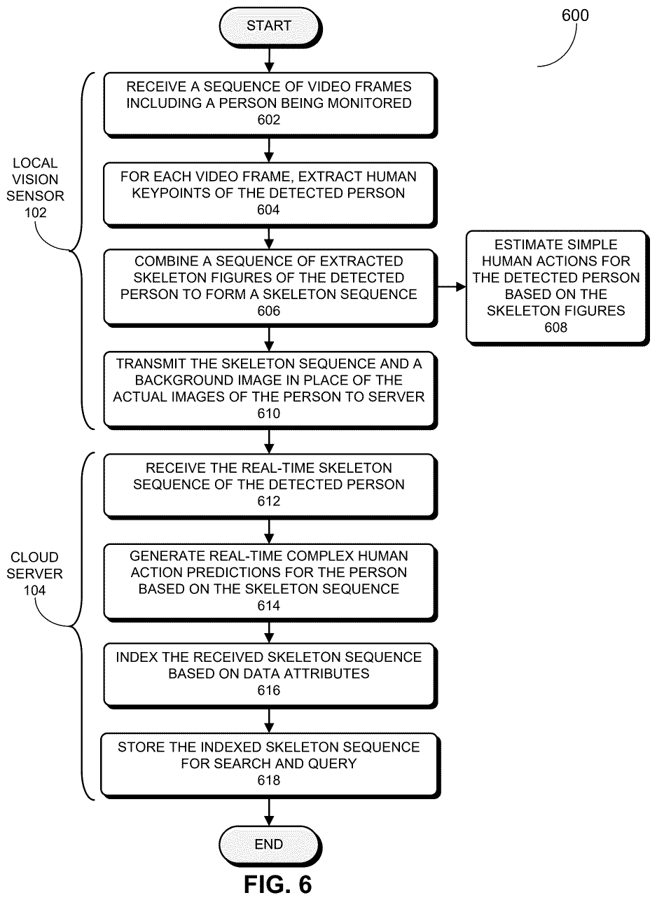

FIG. 6 presents a flowchart illustrating an exemplary process for performing real-time human-action recognition using the disclosed joint human-action recognition system 100 in accordance with some embodiments described herein. In one or more embodiments, one or more of the steps in FIG. 6 may be omitted, repeated, and/or performed in a different order. Accordingly, the specific arrangement of steps shown in FIG. 6 should not be construed as limiting the scope of the technique.

Process 600 may begin by receiving a sequence of video frames including a person being monitored (step 602). For example, the sequence of video frames may be captured by a camera installed at an assisted living facility or a nursing care home, and the one or more persons being monitored can be elderly people living in the assisted living facility or the nursing care home. Next, for each video frame in the sequence of video frames, process 600 detects the person in the video frame, and subsequently extracts a set of human keypoints of the detected person from the detected person image (step 604). Note that process 600 performs step 604 locally on a local vision sensor/smart camera where the sequence of video frames are captured. For example, process 600 can used the above described pose estimation module 202 to perform person detection and human keypoint extraction. Process 600 subsequently combines a sequence of extracted skeleton figures of the detected person extracted from the sequence of video images to form a skeleton sequence of the detected person which depicts a continuous motion of the detected person (step 606). Note that process 600 performs step 606 locally on the local vision sensor/smart camera where the sequence of video frames are captured.

Process 600 next estimates some simple human actions for the detected person based on the sequence of extracted skeleton figures (step 608). For example, process 600 can perform a deep-learning-based action recognition based on the configuration of each set of extracted human keypoints and/or localizations of the associated set of keypoints, and subsequently generate an action label for the detected person in each video frame. As described above, the types of simple human actions that can be predicated at step 608 can include standing, sitting down, lying down, fall detection, and waving hand detection. Note that process 600 performs step 608 locally on the local vision sensor/smart camera where the sequence of video frames are captured. For example, process 600 can used the above described simple-action recognition module 204 to perform these simply human action estimations. In some embodiments of process 600, step 608 is an optional step.

Next, process 600 transmits the skeleton sequence of the detected person and a background image common to the sequence of video frames in place of the actual images of the detection person from the local vision sensor to a cloud server (step 610). Note that process 600 does not transmit the actual images of the detected person to the cloud server, and the transmitted skeleton sequence of the detected person and the background image do not include any PII. Consequently, the privacy of the detected person is preserved and protected during the human action data transmission of step 610. Note that all steps 602-610 take place in real-time as the detected person is being monitored.

Next, process 600 receives the real-time skeleton sequence of the detected person at the cloud server (step 612). Process 600 subsequently generates real-time complex human action predictions for the detected person based on the received skeleton sequence using deep-learning techniques and big-data analytics (step 614). As described above, these complex human actions can include eating, cooking, certain manners of falling, or diagnosis of certain behavioral diseases such as dementia, Parkinson's, and depression. Note that process 600 performs step 612 on the cloud server, e.g., using complex-action-recognition module 408, which includes significantly higher computational resources and storage space than the local vision sensor where the original video frames are captured. Process 600 subsequently re-organizes the received skeleton sequence by indexing the received skeleton sequence based on one or more data attributes (step 616). These data attributes that can be used to index the received skeleton sequence can include, but are not limited to: people IDs, camera IDs, group IDs (e.g., people that belong to different monitoring groups), and recording timestamps. Process 600 then stores the indexed skeleton sequence into an indexing database so that the newly-received skeleton sequence can be efficiently searched, queried, and post-processed by various user applications (step 618). Consequently, process 600 uses the local vision sensor and the cloud server jointly and concurrently to achieve privacy-preserving complex human action recognitions for the detected people in real-time.

### Mitigating False Alarms and Missed Detections of the Local Vision Sensors

As described above in conjunction with FIGS. 1-6, joint human-action recognition system 100, which includes local vision sensor 102, cloud server 104, and mobile app 422, is a privacy-preserving intelligent activity sensing system capable of performing fall detections. Also as described above in conjunction with FIGS. 1-2, local vision sensor 102 can use an AI chip or an AI processor (e.g., implemented by a processor 1004 in the hardware environment 1000) and the associated deep-learning models embedded with local vision sensor 102 to process captured people-monitoring videos and detect personal falls. To protect privacy of the detected or monitored persons, local vision sensor 102 transmits the extracted skeleton (or stick figure) animations/sequences in place of the raw human images to cloud server 104 and to mobile app 422, to represent the captured human movements, without transmitting the real human images.

Even though local vision sensor 102 of the joint human-action recognition system 100 can estimate a personal fall using the embedded AI processor/chip and the associated deep-learning modules based on the extracted skeleton figures, the embedded AI processor/chip generally has limited computational resources, including limited computational power, data throughput and storage space. Due to the limited computational resources in the AI processor/chip, using local vision sensor 102 to perform fall detections based on the extracted skeleton figures is subjected to two types of problems: (1) false alarms; and (2) missed detections. Note that a false alarm in the fall detection refer to an scenario when a person being monitored is not involved in a fall, but the deep-learning model within local vision sensor 102 decides that the monitored person has fallen. On the other hand, a missed detection represents that a person being monitored is actually involved in a fall but the fall is not detected by the deep-learning model within local vision sensor 102.

To solve the above-described problems, a traditional approach is to increase the sensitivity of the fall detection model running in vision sensor 102 to reduce the missed detections. However, this approach in turn increases the false alarms. To mitigate these false alarms, human operators have to be used to review each received fall detection alert generated by vision sensor 102. Unfortunately, involving human operators significantly increases the cost of fall-detection operations by vision sensor 102. Recently, the performance of large-scale AI models has been evolving and improving rapidly and begin to outperform human in doing many tasks. Some powerful large-scale AI models include ChatGPT™ from OpenAI™ and Claude™ from Anthropic™ ai. However, to run these large-scale AI models on vision sensor 102 would require equipping vision sensor 102 with very powerful and expensive AI chips, which would significantly increase the associated hardware cost. Moreover, including powerful AI chips into vision sensor 102 also requires the re-design of the hardware components of vision sensor 102.

As mentioned above, the cloud server 104 includes significantly higher computational resources including computational power and storage space than local vision sensor 102. Hence, joint human-action recognition system 100 can be configured to leverage the computational power of cloud server 104 to significantly improve the fall detection results of local vision sensor 102. In this disclosure, we propose techniques to operate a large vision-language AI model (VLM) running on cloud server 104 in conjunction with local vision sensor 102 to detection personal falls. The disclosed techniques have the capabilities of reducing both false alarms and missed detections associated with local vision sensor 102 during fall detections, without the need to change the hardware of local vision sensor 102 and without involving human operators. Note that however, in the disclosed embodiments, some modifications of the fall detection modules/models in local vision sensor 102 would be required.

More specifically, one or more large VLMs (e.g., a VLM similar to those implemented on OpenAI™) can be implemented within cloud server 104. In some embodiments, the one or more large VLMs can be implemented on or integrated with complex-action-recognition module 408 as one or more VLMs 450 in FIG. 4 within cloud server 104. In some other embodiments, the one or more large VLMs can be implemented as a separate fall-detection module from complex-action-recognition module 408 within cloud server 104 (not explicitly shown in FIG. 4). Operating in tandem with local vision sensor 102, the one or more large VLMs on cloud server 104 (e.g., the one or more VLMs 450) are configured to receive both fall alerts/alarms (e.g., through fall/non-fall decisions 460 in FIG. 4) and the associated raw images (e.g., through snapshot images 462 in FIG. 4) from local vision sensor 102 when falls are predicted by local vision sensor 102. The one or more large VLMs then operates to automatically detect and filter out false fall alerts/alarms (or simply “false alarms”) generated by local vision sensor 102 without involving human operators. As a result, the false alarms and false alarm rate of fall detections by local vision sensor 102 can be significantly reduce, thereby improving the sensitivity and true fall-detection rate of joint human-action recognition system 100.

In some embodiments, to reduce the missed detections by local vision sensor 102, when local vision sensor 102 does not detect a fall based on a captured video image, local vision sensor 102 still transmits an associated raw video image to cloud server 104 when a set of predetermined conditions are met. The one or more large VLMs (e.g., the one or more VLMs 450) then operate on the associated raw video image to make a final fall/non-fall decision. Note that the one or more large VLMs in cloud server 104 has significantly higher capability and accuracy to detect various forms of true falls than local vision sensor 102, because the large VLMs have been trained using a much larger training dataset than the dataset for training a fall-detection model in local vision sensor 102. This is because the training dataset for training the large VLMs is constructed to accommodate as many types of true fall scenarios as possible, whereas the training dataset for the fall-detection model in local vision sensor 102 is constructed to recognize a set of predefined, simple human actions. However, these large VLMs running on cloud server 104 are also quite expensive, because they are running on computers equipped with expensive AI processors such as one or more graphic processing units (GPUs). Hence, in this disclosure, techniques to reduce the number of unnecessary calls to these large VLMs are also described, which allow for reducing the cost of the overall fall-detection operations by joint human-action recognition system 100.

Moreover, the one or more large VLMs (e.g., the one or more VLMs 450) implemented on cloud server 104 can also enable the joint human-action recognition system 100 to extract other useful information about the health of the monitored people based on the data submitted by local vision sensor 102. Note that the disclosed cloud server 104 integrated with the one or more large VLMs (e.g., the one or more VLMs 450) can receive fall detection data generated and submitted by multiple local vision sensors (i.e., multiple instances of local vision sensor 102) installed at a given health-care facility.

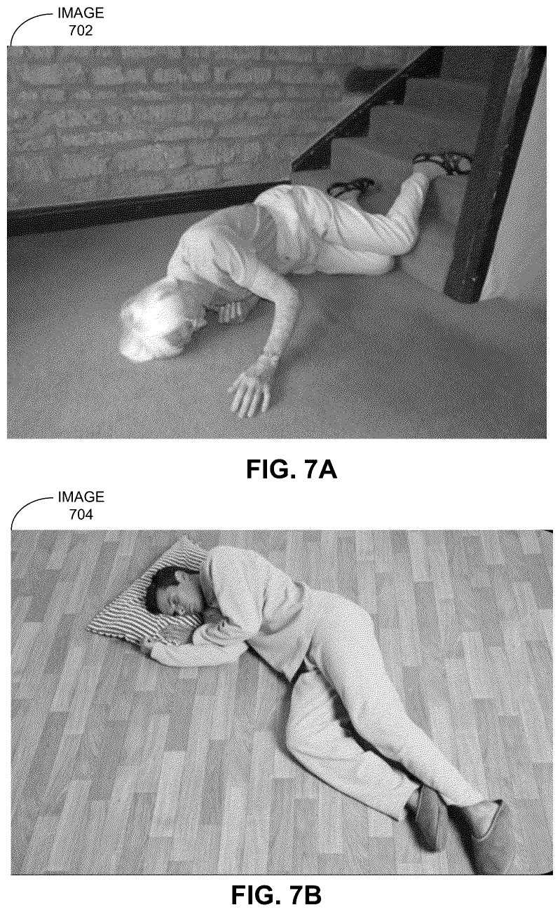

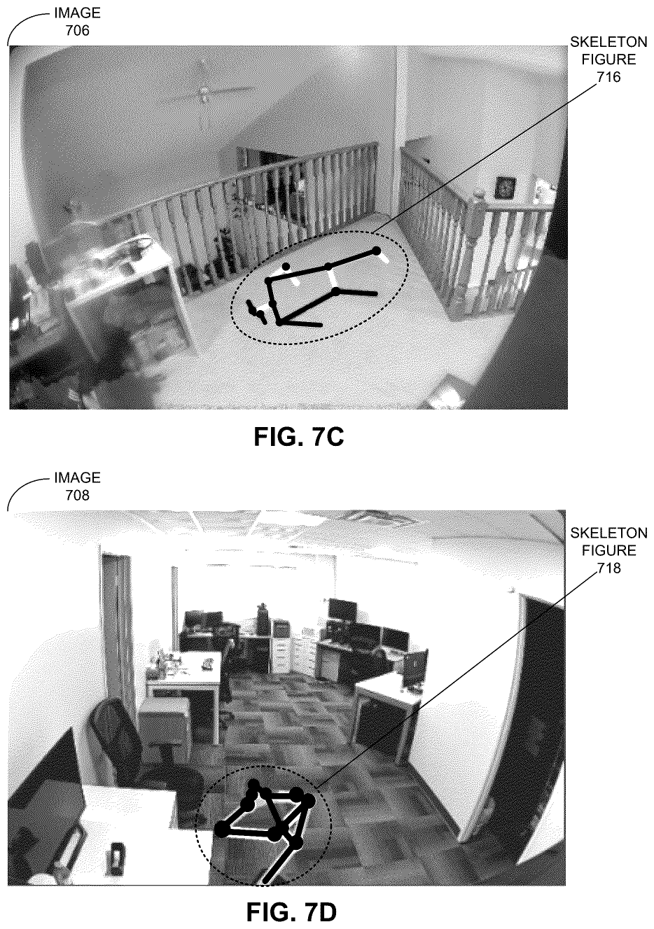

FIG. 7A illustrates an image 702 depicting an exemplary true fall event. As can be seen in FIG. 7A, the image appears to depict an elderly person who has fallen near a staircase. Note that falls like this case can happen due to a variety of reasons, including, but not limited to: loss of balance, tripping, poor lighting, and health issues such as dizziness or weakness. When a true fall event is detected, immediate attention should be given to the subject of the fall to ensure the person's safety and well-being and to check for potential injuries. It is critically important to handle the subject of the fall carefully to avoid worsening of any potential injuries. Emergency medical assistance should be contacted if injuries are indeed occurred. Generally, both the local vision sensor 102 using simple-action recognition module 204 and the cloud server 104 integrated with the one or more large VLMs (e.g., the one or more VLMs 450) can correctly recognize this true fall event.

FIG. 7B illustrates an image 704 depicting an exemplary event of a person who is sleeping on the floor but with a posture almost identical to a fall. As can be seen in FIG. 7B, the image appears to show the person lying on the floor in a relaxed position, potentially asleep or resting, with a pillow for support. Unlike the previous image 702 in FIG. 7A, image 704 does not suggest a fall or otherwise an emergency scenario, because the person's action in image 704 appears to be intentional and the person's posture in image 704 appears to be relaxed and in a natural posture. When analyzing image 704 in the context of action recognition or fall detection, the action recognition or fall detection system should be configured to differentiate between intentional actions, such as lying down, and accidental events, such as falls. Note that the local vision sensor 102 using simple-action recognition module 204 may label the depicted event of image 704 as a fall, which would be a false alarm. However, the cloud server 104 integrated with the one or more large VLMs (e.g., the one or more VLMs 450) can correctly recognize that the depicted event of image 704 is a not a fall. Hence, when jointly used in joint human-action recognition system 100, the cloud server 104 can be used to correct a potential false alarm of a fall generated by the local vision sensor 102 when image 704 is the input to the system 100.

FIG. 7C illustrates an image 706 depicting an extracted skeleton FIG. 716 of a detected person in the image that appears to have fallen in accordance with some embodiments described herein. As can be seen in FIG. 7C, some of the strongest indicators of a person who has fallen based on skeleton FIG. 716 include, but are not limited to:
(1) skeleton FIG. 716 is oriented horizontally on the ground, with both the torso and the legs segments of skeleton FIG. 716 aligned parallel to the ground/floor;
(2) the head and limbs segments of skeleton FIG. 716 are spread out in a manner that suggests an uncontrolled/unnatural or collapsed posture that is consistent with a fall; and
(3) the position of the skeleton FIG. 716 does not indicate any active sitting, crouching, or deliberate action, which further supports the likelihood of a fall.

In the example of FIG. 7C, local vision sensor 102 using simple-action recognition module 204 to run a fall detection model on skeleton FIG. 716 may predict/infer skeleton FIG. 716 as a non-fall event, which causes a missed detection. However, the disclosed cloud server 104 integrated with the one or more large VLMs (e.g., the one or more VLMs 450) can correctly recognize the depicted event in image 706 as a true fall event.

FIG. 7D illustrates an image 708 depicting an extracted skeleton FIG. 718 of a detected person in the image that does not appear to have fallen in accordance with some embodiments described herein. As can be seen in FIG. 7D, skeleton FIG. 718 appears to represent a person in a crouching or seating position on the floor. Some of the strongest indicators that supports skeleton FIG. 718 in a crouching or seating position include, but are not limited to:
(1) the torso and head segments of skeleton FIG. 718 are oriented forward, with the arms bent and possibly supporting the body;
(2) the leg segments of skeleton FIG. 718 are significantly bent at the knees, suggesting a deliberate crouch rather than an uncontrolled fall; and
(3) the overall posture of skeleton FIG. 718 does not exhibit the horizontal alignment with the floor/ground that is typically associated with a fall.
   In the example of FIG. 7D, local vision sensor 102 using simple-action recognition module 204 to run a fall detection model on skeleton FIG. 718 may predict/infer skeleton FIG. 718 as in a fall, which would be a false alarm. However, the disclosed cloud server 104 integrated with the one or more large VLMs (e.g., the one or more VLMs 450) can correctly recognize that the depicted event in image 708 is a not a fall.

FIG. 8 present a flowchart illustrating a process 800 of detecting personal falls while reducing false alarms by jointly operating a local vision sensor and a cloud server in accordance with some embodiments described herein. In one or more embodiments, one or more of the steps in FIG. 8 may be omitted, repeated, and/or performed in a different order. Accordingly, the specific arrangement of steps shown in FIG. 8 should not be construed as limiting the scope of the technique.

To begin process 800, a local vision sensor processes one or more video frames/images capturing a monitored person using an embedded fall detection model within the local vision sensor (step 802). For example, the local vision sensor 102 can use simple-action recognition module 204 running a fall detection model on the one or more latest video frames of the received video frames 230 to detect a fall of the monitored person. In some embodiments, the fall detection model can process the most recent video frame, i.e., the newest video frame of the received video frames 230 to detect a fall of the monitored person. In other embodiments, the fall detection model can process the latest few video frames, i.e., the newest video frame plus one or more preceding video frames of the received video frames 230 to detect a fall of the monitored person.

When a fall is detected by the local vision sensor for the monitored person, the local vision sensor obtains a raw image of the monitored space (e.g., a monitored room, or a monitored hallway) when the fall is detected (step 804). In some embodiments, the local vision sensor obtains the raw image by capturing a real-time image of the monitored space. In some other embodiments, instead of capturing a real-time image of monitored space, process 800 can also use the original/unprocessed image associated with the most-recently processed video frame by the local vision sensor as the raw image of the monitored space. From the local vision sensor's perspective, this most-recent/newest raw image provides a real-time “snapshot” of the detected fall, and therefore is also referred to as the “snapshot image” of the monitored space hereinafter. Note that this snapshot image is the raw unprocessed image taken directly by the local vision sensor. Next, the local vision sensor transmits the snapshot image of the monitored space and the generated fall (detection) alert to the cloud server, such as cloud server 104 (step 806).

Continuing with process 800, which subsequently takes place on the cloud server, such as cloud server 104, the cloud server receives the fall (detection) alert and the associated snapshot image of the monitored space from the local vision sensor (step 808). Next, the cloud server applies one or more large VLMs (e.g., the one or more VLMs 450) on the snapshot image to detect an actual fall (step 810) and subsequently determines if a fall has actually occurred in the monitored space (step 812). As mentioned above, each of the one or more large VLMs of the cloud server has significantly higher capability and accuracy to detect various forms of true falls than the local vision sensor 102, because the one or more VLMs has been trained using much larger datasets associated with many more types of true fall scenarios, than the dataset for training the fall-detection model embedded on the local vision sensor 102.

Continuing with process 800, if the cloud server determines that a true fall has been detected by the one or more large VLMs on the received snapshot image, the cloud server sends the fall alert to one or more users of the disclosed fall detection system, e.g., to the mobile app 422 of the joint human-action recognition system 100 (step 814). However, if the cloud server determines that no fall has been detected by the one or more large VLMs on the received snapshot image, process 800 determines that the local vision sensor has generated a false alarm and disregards/ignores the received fall (detection) alert from the local vision sensor (which includes not sending any fall alert to the user's mobile app) (step 816). By detecting a false alarm and ignoring such a fall alarm, process 800 operates to reduce the false alarms.

In some embodiments, to protect the privacy of the monitored person, the snapshot image described in conjunction with FIG. 8 can be encrypted (e.g., using an end-to-end encryption) during the transmission from the local vision sensor to the cloud server. Next, the snapshot image received by the cloud server is discarded after the snapshot image has been processed by the one or more large VLMs on the cloud server. Because the snapshot image is not saved on the cloud server, the user/service provider of the disclosed fall-detection system will not be able to access the snapshot images.

Note that the fall-detection techniques described above in conjunction with FIG. 8 can significantly reduce false alarms when compared with the results of using local vision sensor 102 alone. However, these techniques are not designed to reduce missed fall detections by the local vision sensor, which is another critically-important requirement for a fall detection system. Note that it is difficult for the simple fall-detection models resided on the local vision sensor to detect all possible forms of falls, because they were trained with small size and limited diversity of training data.

On the other hand, the one or more large VLMs in the cloud server (e.g., the one or more VLMs 450 in FIG. 4) have significantly higher capability to detect various forms of actual falls, because they were trained using much larger and diverse training datasets. It would be ideal to run the large VLMs to verify each not-a-fall decision (also referred to as “non-fall decision”) generated by the local vision sensor. However, these large VLMs running on the cloud server are also very expensive to run, because they are running on computers equipped with expensive AI processors such as one or more expensive and high-power, high-performance GPUs. As a result, it is impractical to call the large VLMs to verify all non-fall decisions generated by the local vision sensor. Hence, this disclosure also provides techniques to reduce the number of unnecessary calls to these VLM models when non-fall decisions are made by the local vision sensor, thereby allowing for reducing the cost of the overall fall-detection operations by joint human-action recognition system 100. In some embodiments, to reduce missed detections by the fall detection model used by the local vision sensor, even when the fall detection model does not detect a fall in a given video frame including a monitored person, the local vision sensor conditionally sends the given video frame to the cloud server when a set of predefined conditions are met, i.e., determined to be TRUE for each and every of the predefined conditions. In some embodiments, the set of predefined conditions includes the following four conditions:
Condition 1: the monitored person is detected in the video frame at a location within a floor area, and the floor area is identified during the initial calibration stage of the local vision sensor; AND
Condition 2: the monitored person in the video frame is not moving or hardly making any movement; AND
Condition 3: the monitored person in the video frame has remained at the current location (i.e., at the detected location within the floor area) for at least a predefined (minimum) time threshold T, e.g., T=45 seconds. This suggests that the monitored person has not left the floor area for at least the time threshold T. In some embodiments, the time threshold T is partially determined such that the fall detection model in the local vision sensor has sufficiently time to be activated; AND
Condition 4: No fall alert has been sent by the local vision sensor for the current location.

Note that the set of predefined conditions are designed to detect as many types of true fall scenarios as possible, and at the same time reducing unnecessary calls to the one or more VLMs in the cloud server to reduce the cloud-based computing cost. In this regard, the time threshold T serves dual purposes and therefore is selected as a trade-off under the circumstance that the local vision sensor has not detected a fall such that: (1) it is the minimum time required to allow the cloud server to be employed to verify the non-fall decisions by the local vision sensor; and (2) it is the maximum time passed (i.e., the maximum wait time) before the cloud server is employed to verify the non-fall decisions to ensure the safety of the monitored person in case of missed detections by the local vision sensor. Note that in other embodiments, the set of predefined conditions to be met can be a subset of the above-listed four conditions, or can include additional predefined conditions not listed above.

FIG. 9 present a flowchart illustrating a process 900 of detection personal falls while simultaneously reducing false alarms and missed detections by jointly operating a local vision sensor and a cloud server in accordance with some embodiments described herein. In one or more embodiments, one or more of the steps in FIG. 9 may be omitted, repeated, and/or performed in a different order. Accordingly, the specific arrangement of steps shown in FIG. 9 should not be construed as limiting the scope of the technique.

To begin process 900, a local vision sensor processes one or more video frames/images capturing a monitored person using an embedded fall detection model within the local vision sensor (step 902). For example, the local vision sensor 102 can use simple-action recognition module 204 running a fall detection model on the one or more latest video frames of the received video frames 230 to detect a fall of the monitored person. Next, process 900 determines if a fall of the monitored person is detected based on the processed one or more video frames (step 904). If so, the local vision sensor obtains a snapshot image of the monitored space (e.g., a monitored room, or a monitored hallway) when the fall is detected (step 906). In some embodiments, the local vision sensor obtains the snapshot image by capturing a real-time image of the monitored space. In some other embodiments, instead of capturing a real-time image of monitored space, process 900 can also use the raw unprocessed image associated with the most-recently processed video frame by the local vision sensor as the snapshot image of the monitored space. Note that this snapshot image is the raw unprocessed image captured by the local vision sensor. Next, the local vision sensor transmits the snapshot image of the monitored space and the associated fall/non-fall decision of the local vision sensor (i.e., herein the fall alert/alarm/decision) to the cloud server, such as cloud server 104 (step 908).

Alternatively at step 904, if process 900 determines that no fall of the monitored person is detected based on the processed one or more video frames, the local vision sensor further determines if the set of predefined conditions is met (step 910). Note that in these embodiments, when a non-fall decision is made by the local vision sensor, the local vision sensor does not automatically send a raw/snapshot image of the monitored area to the cloud server to verify the non-fall decision. Instead, sending the snapshot image to the cloud server for the non-fall verification is conditional in accordance with meeting the set of predefined conditions. This conditional employment of the cloud server for non-fall verification allows for reducing the number of unnecessary calls to the VLMs on the cloud server, and thereby reducing overall computing cost.

As mentioned above, the set of predefined conditions are designed to detect as many types of true fall scenarios as possible, and at the same time reducing unnecessary calls to the VLMs to reduce the cloud-based computing cost. Hence, at step 910, if it is determined that all the conditions in the set of predefined conditions are met, process 900 obtains a raw snapshot image of the monitored space from which the non-fall decision is made (step 912), and subsequently returns to step 908 to transmit the snapshot image and the associated fall/non-fall decision of the local vision sensor (i.e., herein the non-fall decision) to the cloud server for verification (step 908). However, if process 900 determines that the set of predefined conditions is not met at step 910, process 900 returns to step 902 where the local vision sensor continues to execution other tasks without transmitting a snapshot image and the non-fall decision to the server. Note that by judicially determining when to transmit snapshot images and the non-fall decisions to the server when non-fall decisions are made by the local vision sensor, unnecessary calls to the second fall detection model on the server are significantly reduced, which in turn significantly reduces computational costs.

Continue with process 900, which subsequently takes place at a cloud server, such as cloud server 104. The cloud server receives the snapshot image of the monitored space and the associated fall/non-fall decision from the local vision sensor (step 914). Next, the cloud server applies one or more large VLMs (e.g., the one or more VLMs 450 in FIG. 4) on the snapshot image to detect a fall and subsequently verify the received fall/non-fall decision (step 916). Next, when a fall is detected by the one or more large VLMs based on the received snapshot image, process 900 determines if the received fall/non-fall decision is a non-fall decision (step 918). If so, process 900 identifies a missed detection by the local vision sensor (step 920) and the cloud server sends a fall alert to the user of the disclosed fall detection system, e.g., to the mobile app 422 of the joint human-action recognition system 100 (step 922). However, if process 900 determines at step 918 that the received fall/non-fall decision is a fall decision, there is no missed detection by the local vision sensor, and the cloud server also sends a fall alert to the user of the disclosed fall detection system (step 922).

As an alternative output of step 916, when a non-fall decision is made by the one or more large VLMs based on the received snapshot image, process 900 subsequently determines if the received fall/non-fall decision is a fall decision/alert (step 924). If so, the cloud server identifies a false alarm by the local vision sensor and subsequently disregards/ignores the received fall decision/alert from the local vision sensor (which includes not sending any fall alert to the user's mobile app) (step 926). However, if process 900 determines at step 924 that the received fall/non-fall decision is a non-fall decision, there is no false alarm by the local vision sensor, and process 900 terminates.

In some embodiments, to protect the privacy of the monitored person, the snapshot image described in conjunction with FIG. 9 can be encrypted (e.g., using an end-to-end encryption) during the transmission from the local vision sensor to the cloud server. Next, the received snapshot image by the cloud server is discarded after the video image has been processed by the one or more large VLMs on the cloud server. Because the snapshot image is not saved on the cloud server, the user/service provider of the disclosed fall-detection system will not be able to access the snapshot images.

In some embodiments described above in conjunction with FIGS. 8 and 9, it is assumed that encrypted raw snapshot images are transmitted to and processed by the cloud server. However, transmitting encrypted raw images may still be a privacy concern for some users. Hence, as an alternative resolution, instead of sending the raw snapshot images to the cloud server for fall/non-fall decision verifications, the associated skeleton figure data of the monitored persons and the background image of the monitored area can be transmitted to the cloud server for the VLMs to verify the fall/non-fall decisions made by the local vision sensor. Note that certain VLMs such as ChatGPT can recognize human actions based on aforementioned human skeleton representations and the associated background image. However, the human-action recognition accuracies using the skeleton figure data are generally lower than the human-action recognition accuracies using the raw/raw video images.

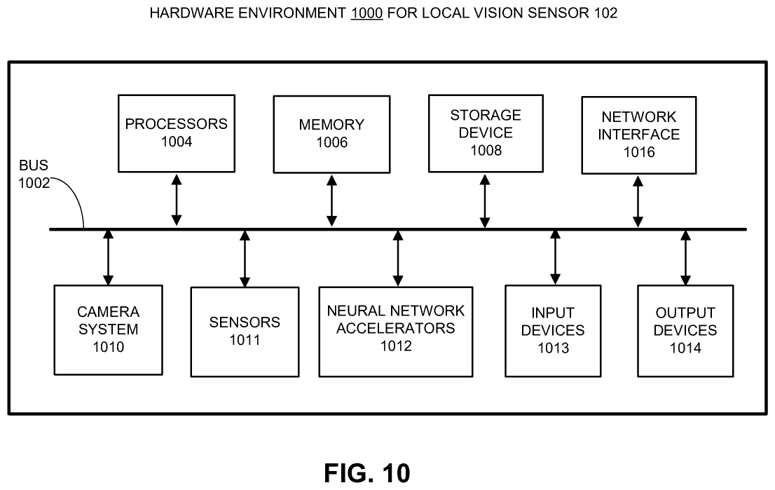

FIG. 10 illustrates an exemplary hardware environment 1000 for the disclosed local vision sensor 102 in the disclosed joint human-action recognition system 100 in accordance with some embodiments described herein. As can be seen in FIG. 10, hardware environment 1000 can include a bus 1002, one or more processors 1004, a memory 1006, a storage device 1008, a camera system 1010, sensors 1011, one or more neural network accelerators 1012, one or more input devices 1013, one or more output devices 1014, and a network interface 1016.

Bus 1002 collectively represents all system, peripheral, and chipset buses that communicatively couple the various components of hardware environment 1000. For instance, bus 1002 communicatively couples processors 1004 with memory 1006, storage device 1008, camera system 1010, sensors 1011, neural network accelerators 1012, input devices 1013, output devices 1014, and network interface 1016.

From memory 1006, processors 1004 retrieves instructions to execute and data to process in order to control various components of hardware environment 1000, and to execute various functionalities described in this patent disclosure including the various disclosed functions of the various functional modules in the disclosed deep-learning subsystem 106, including but not limited to: pose-estimation module 202, simple-action recognition module 204, face-detection module 206, and face-recognition module 208. Processors 1004 can include any type of processor, including, but not limited to, one or more central processing units (CPUs), one or more microprocessors, one or more graphic processing units (GPUs), one or more tensor processing units (TPUs), one or more digital signal processors (DSPs), one or more field-programmable gate arrays (FPGAs), one or more application-specific integrated circuit (ASICs), a personal organizer, a device controller and a computational engine within an appliance, and any other processor now known or later developed. Furthermore, a given processor 1004 can include one or more cores. Moreover, a given processor 1004 itself can include a cache that stores code and data for execution by the given processor 1004.

Memory 1006 can include any type of memory that can store code and data for execution by processors 1004, neural network accelerators 1012, and some other processing modules of hardware environment 1000. This includes but not limited to, dynamic random access memory (DRAM), static random access memory (SRAM), flash memory, read only memory (ROM), and any other type of memory now known or later developed.

Storage device 1008 can include any type of non-volatile storage device that can be integrated with hardware environment 1000. This includes, but is not limited to, magnetic, optical, and magneto-optical storage devices, as well as storage devices based on flash memory and/or battery-backed up memory. In some implementations, various programs for implementing the various disclosed functions of the various disclosed modules in the disclosed deep-learning subsystem 106 of local vision sensor 102, including but not limited to: pose-estimation module 202, simple-action recognition module 204, face-detection module 206, and face-recognition module 208, are stored in memory 1006 and storage device 1008.

Bus 1002 is also coupled to camera system 1010. Camera system 1010 is configured to capture a sequence of video images at predetermined resolutions and couple the captured video images to various components within hardware environment 1000 via bus 1002, such as to memory 1006 for buffering and to processors 1004 and neural network accelerators 1012 for various deep-learning and neural network-based operations. Camera system 1010 can include one or more digital cameras. In some embodiments, camera system 1010 includes one or more digital cameras equipped with wide-angle lenses. The captured images by camera system 1010 can have different resolutions including high-resolutions such as at 1280×720 p, 1920×1080 p or other high resolutions.

In some embodiments, neural network accelerators 1012 can include any type of microprocessor designed as hardware acceleration for executing AI-based and deep-learning-based programs and models, and in particular various deep learning neural networks such as various CNN and RNN frameworks mentioned in this disclosure. Neural network accelerators 1012 can perform the intended functions of each of the described deep-learning-based modules within the disclosed deep-learning subsystem 106 of local vision sensor 102, including but not limited to: pose-estimation module 202, simple-action recognition module 204, face-detection module 206, and face-recognition module 208. Examples of neural network accelerators 1012 can include but are not limited to: the dual-core ARM Mali-G71 GPU, dual-core Neural Network Inference Acceleration Engine (NNIE), and the quad-core DSP module in the HiSilicon Hi3559A SoC.

Bus 1002 also connects to input devices 1013 and output devices 1014. Input devices 1013 enable the user to communicate information and select commands to hardware environment 1000. Input devices 1013 can include, for example, a microphone, alphanumeric keyboards and pointing devices (also called “cursor control devices”).

Hardware environment 1000 also includes a set of sensors 1011 coupled to bus 1002 for collection environment data in assisting various functionalities of the disclosed local vision sensor 102. Sensors 1011 can include a motion sensor, an ambient light sensor, and an infrared sensor such as a passive infrared sensor (PIR) sensor. To enable the functionality of a PIR sensor, hardware environment 1000 can also include an array of IR emitters.

Output devices 1014 which are also coupled to bus 1002, enable for example, the display of the results generated by processors 1004 and neural network accelerators 1012. Output devices 1014 include, for example, display devices, such as cathode ray tube displays (CRT), light-emitting diode displays (LED), liquid crystal displays (LCD), organic light-emitting diode displays (OLED), plasma displays, or electronic paper. Output devices 1014 can also include audio output devices such as a speaker. Output devices 1014 can additionally include one or more LED indicators.

Finally, as shown in FIG. 10, bus 1002 also couples hardware environment 1000 to a network (not shown) through a network interface 1016. In this manner, hardware environment 1000 can be a part of a network, such as a local area network (“LAN”), a Wi-Fi network, a wide area network (“WAN”), or an Intranet, or a network of networks, such as the Internet. Hence, network interface 1016 can include a Wi-Fi network interface. Network interface 1016 can also include a Bluetooth interface. Any or all components of hardware environment 1000 can be used in conjunction with the subject disclosure.

Note that while we have described various embodiments of the joint human-action recognition system 100 based on using human skeleton/keypoint representations, the general concept of performing human action recognitions, transmitting, storing and retrieving human action sequences using a type of privacy-preserving human representation/data format is not limited to just human skeleton/keypoint representation/data format. In various other embodiments of the joint human-action recognition system 100, the raw videos can also be converted to another type of privacy-preserving data format other than the human skeleton/keypoint data format. These alternative privacy-preserving data formats that can be used in the disclosed joint human-action recognition system 100 in place of the human skeleton/keypoint data format to represent a detected person can include, but are not limited to: a 3D mesh of human body; a human outline (e.g., mask, silhouette, or 3D mesh) representation of a human body; thermal images of a detected person; depth maps of a detected person generated by depth cameras; and human body representation by other radar sensors (e.g., millimeter wave sensors).

Note that when using an alternative privacy-preserving data format, such as a human outline format in place of the above-described human skeleton/keypoint data format in the disclosed joint human-action recognition system 100, the disclosed local vision sensor is configured to convert the detected persons in the raw video images into this alternative privacy-preserving data format, and perform simple action recognition such as fall detection on the disclosed local vision sensor. The disclosed local vision sensor is further configured to transmit a converted/extracted human-action sequence data in the alternative privacy-preserving data format in place of the raw person images to the cloud server, thereby fully preserving and protecting the privacy of the detected person. On the cloud server, the human-action sequence data in the alternative privacy-preserving data format can be further processed (e.g., to perform complex action recognitions), indexed, stored, later retrieved, and played back at a later time in similar manners as described-above in the scope of the human skeleton/keypoint data format.

### Low-Cost Storage of Skeleton Sequences

As described above, the disclosed smart visual sensor 102 is configured to extract and transmit the skeleton sequence of a detected person from a sequence of raw video frames in real time when a video is being captured. In some embodiments, the extracted skeleton sequences by the disclosed smart visual sensor 102 can be stored in place of the raw video frames from which the skeleton sequences are extracted. A person of ordinary skill can appreciate that only a very small amount of storage space is needed to store the disclosed structured human action sequence data, i.e., the skeleton figures/skeleton sequences compared to saving the raw video images/videos.

For example, if 18 keypoints are used to represent a single skeleton figure, each keypoint in the set of keypoints can be represented by an associated index, 2D or 3D coordinates, and a probability value as described above. Moreover, each extracted skeleton figure can be associated with additional labels and properties. For example, these additional labels and properties can include a recognized action label (by simple-action recognition module 204) and the corresponding probability. When combined, each extracted skeleton figure in the disclosed skeleton sequence will require less than 250 bytes to represent all the information. The size of skeleton-figure data can be further reduced by using certain existing lossless compression techniques, which can easily reduce the required storage space by additional 50% or more.

Using the maximum byte size of 250, if the frame rate of the recorded skeleton sequence is 10-frame/second, then the data rate can be reduced to 2500 bytes/sec per recorded person. As such, one hour of the recorded skeleton sequence will only have 9 MB data size, which is merely 2% of the typical 360 p video storage requirement, and 0.4% of the 820 p video storage requirement mentioned above. Even if the frame rate of the recorded video is scaled up to 25-fps which is the recommended frame rate of YouTube videos, the storage requirement of the disclosed skeleton sequence is still only 5% of the 360 p video storage requirement, and 1% of the 820 p video storage requirement. Note that all of above comparisons are made without applying any compression to the recorded skeleton sequence.

Using the disclosed smart visual sensor 102 and the disclosed skeleton sequence extraction and storage techniques, assuming a person being monitored is active for 16 hours each day, the captured skeleton sequence data will have a size of at most 9×16=144 MB/day (using 250-byte/figure as upper limit), or 4.32GB/month. This suggests that the associated monthly storage cost/monitored person is only about $0.1 (using common commercial cloud storage pricing). In comparison, a 30-day subscription fee for common video storage is $30 from a well-known video surveillance company. Note that a direct consequence of a significantly reduced per-person monthly storage/storage cost requirement is that, for the same storage duration, the disclosed structured human-action data offer much lower monthly storage cost. Alternatively, for the same monthly storage cost, the disclosed structured human-action data would allow a much longer storage time, and even life-long data storage can become possible.

### Applications Based on Structured Skeleton-Sequence Data

Note that because the storage of the skeleton sequences of the detected persons generated by the disclosed joint human-action recognition system 100 is only a few percentage (%) of that of the raw/original video data, it becomes very affordable to any user to store the extracted skeleton sequences of full videos (not just some short event clips) in place of the original videos for a much longer storage time in the server, without violating people's privacy (because no actual face images are transmitted and stored). For example, for the same storage duration, using the disclosed joint human-action recognition system 100 and the disclosed skeleton-sequence data structure can result in much lower storage spaces and monthly storage costs. Alternatively, for the same monthly fee, a user can be provided with much longer storage time, even life-long data storage is possible.

Note that the disclosed joint human-action recognition system 100 integrates the functions of three types of conventional medical systems: a medical alert system; a surveillance video system; and a telemedicine system.

Note that storing skeleton figures/sequences in place of original images of the detected persons can result in a very small amount of data being stored for the detected persons. The stored skeleton figures/sequences of a large number of detected people can be used to construct a skeleton figures/sequences database, and searching through such a skeleton figures/sequences database can be extremely fast. In an exemplary mobile App of the disclosed joint human-action recognition system 100 that implements such a skeleton figures/sequences database, users can search through the stored skeleton data, play back the desired skeleton sequences/clips at a specified date, time, and location, or play back the skeleton sequence of a person at a specified date and time.

In some surveillance applications, both the extracted structured skeleton data and (1) face or (2) human body subimages extracted from the original video images can be stored on the server. By combining the structured skeleton data with one of (1) face and (2) human body subimages, the proposed surveillance systems based on the disclosed joint human-action recognition system 100 can achieve a good tradeoff between preserving important identifiable personal information (e.g., based on face or human body subimages) and reducing the server storage.

Some mobile app implementations of the disclosed joint human-action recognition system 100 can also provide certain useful statistics based on the output data of the disclosed joint human-action recognition system 100. For example, an exemplary mobile app can include a heat map function for visualizing how long a detected person spends in each area of the home.

Note that because entire skeleton sequences of the detected persons from an original video can be stored in cloud server 104, even if the emergency detection functions on the disclosed local vision sensor 102 fail to detect certain emergency events, the stored skeleton sequences of the detected persons can still be used to help the event analysis and review afterwards on cloud server 104.

Some mobile App implemented for the disclosed joint human-action recognition system 100 can also include an API that can be integrated with popular Electronic Medical Record (EMR) platforms used by many hospitals and healthcare facilities. This API provides a portal to the EMR platforms to access a new type of valuable patient data—the daily human action skeleton data. Through the API function of the disclosed mobile App implementations, the disclosed local vision sensor 102 becomes a useful new medical device for doctors and patients. The doctors can use the skeleton figure/sequence data generated by the disclosed local vision sensor 102 to observe the behaviors of patients from their home, e.g., to collect information such as how many times a given patient goes to the kitchen and eats each day, or if another patient sits at one location for a long period of time. Note that even if these patients cannot provide accurate feedback by themselves, skeleton figure/sequence data collected remotely and automatically for these patients can be used to evaluate the efficiency of the treatments or rehabilitations for many diseases, such as dementia, Parkinson's disease, depression, autism, mental diseases, and other conduct disorders, and subsequently adjust the treatments based on the evaluation results.

The disclosed structured human-action/skeleton data can also be used by other organizations in additional medical application. For example, senior care facilities and home care companies can use the disclosed structured human-action/skeleton data to provide care to seniors. Insurance companies can use the disclosed structured human-action/skeleton data to evaluate the health condition of a given person and determine proper insurance premiums for the given person. Insurance companies and the governments can also use the disclosed structured human-action/skeleton data to evaluate the quality of services provided by home care workers for seniors or patients that require home cares, and subsequently determine a proper payment level to the care workers. Furthermore, pharmaceutical companies can use the disclosed structured human-action/skeleton data to evaluate the efficacy of new drugs that they've developed. Moreover, university researchers can use the disclosed joint human-action recognition system 100 to perform a wide range of medical researches.

In addition to the aforementioned recording, extraction, storage and playback functionalities, various big-data analytics functionalities can be developed based on the skeleton sequence data collected by the disclosed local vision sensor 102 and stored on the server. For example, advanced machine learning models can be trained to perform some inference tasks on the stored skeleton sequence data, e.g., for early diagnosis of certain conditions from the skeleton data, such as dementia and Parkinson's. Note that such early diagnoses can be crucial to the early treatment, and are beneficial for patients and their families, because they can result in substantial cost savings to the patients and the healthcare systems.

Note that the abilities to perform various aforementioned medical applications without violating the privacy of the people being monitored can be especially useful in the wake of COVID-19 pandemic, as a growing number of people are choosing to use telemedicine technologies.

### Alternative Skeleton Data Solutions

In some application cases, traditional surveillance video camera systems are already in use, which could be expensive to replace with the disclosed smart vision sensors such as local vision sensor 102. In such cases, to reduce the storage cost at the server, the raw videos can be first uploaded to the cloud server by these traditional systems. Subsequently at the cloud server, the disclosed structured skeleton data extraction and other functionalities described in conjunction with FIGS. 1-2 can be used to extract the structured skeleton data, which are then stored on the cloud server. The original uploaded video can then be deleted from the server. Note that this hybrid approach can also reduce the storage cost at the server, but it would still need the same uploading bandwidth as for uploading traditional surveillance videos, and does not provide the same level of user privacy protection as the disclosed local vision sensor 102.

Another option is to install a local server or hub that includes a copy of the disclosed local vision sensor 102 in a facility or a house, which is connected to the stored traditional surveillance videos in the facility or the house by wired or wireless networks. The raw videos recorded by traditional cameras can be converted to skeleton sequences by the disclosed local vision sensor, and the skeleton sequences are then transmitted to the cloud server for long-term storage and analysis. The disclosed local server can be implemented with a desktop computer, or alternatively implemented by a powerful embedded device. After generating the skeleton sequences, the original surveillance videos can be deleted, or kept in the disclosed local server for some time, until the hard disk of the local server is full. At this point, the local server can overwrite old videos with newly recorded videos. This process can also protect the privacy of the users because the original videos are not sent to the cloud server.

While this patent document contains many specifics, these should not be construed as limitations on the scope of any invention or of what may be claimed, but rather as descriptions of features that may be specific to particular embodiments of particular inventions. Certain features that are described in this patent document and attached appendix in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document and attached appendix should not be understood as requiring such separation in all embodiments.

Only a few implementations and examples are described and other implementations, enhancements and variations can be made based on what is described and illustrated in this patent document and attached appendix.

What is claimed is:

1. A computer-implemented method of automatically detecting personal falls through video monitoring on behalf of a user, the method comprising:
at a local vision sensor,
capturing a video of a monitored space including at least one monitored person;
processing one or more video frames of the video using a first fall detection model to detect a fall of the at least one monitored person; and
in response to detecting a fall of the at least one monitored person, transmitting a raw image of the monitored space and a fall alert to a server; and
at the server,
receiving the raw image of the monitored space and the associated fall alert from the local vision sensor;
processing the raw image using a second fall detection model to detect a fall of the at least one monitored person; and
in response to determining that no fall has occurred of the at least one monitored person,
identifying the received fall alert from the local vision sensor as a false alarm; and
disregarding the received fall alert, thereby reducing a number of false alarms.

2. The computer-implemented method of claim 1, wherein the first fall detection model includes a first deep-learning model configured to detect a fall based on recognizing a set of predetermined human actions.

3. The computer-implemented method of claim 2, wherein the local vision sensor includes an embedded artificial intelligence (AI) processor for executing the deep-learning-based fall detection model, and wherein the embedded AI processor is associated with limited computational resources.

4. The computer-implemented method of claim 2, wherein processing each of the one or more video frames of the video includes:
extracting at least one skeleton-figure representation of the at least one monitored person, wherein the at least one skeleton-figure representation does not include personal identifiable information (PII) of the at least one monitored person; and
applying the first deep-learning model on the at least one skeleton-figure representation to detect a fall of the at least one monitored person.

5. The computer-implemented method of claim 1,
wherein prior to transmitting the raw image of the monitored space, the method further comprises obtaining the raw image by capturing a real-time image of the monitored space; and
wherein transmitting the raw image of the monitored space includes transmitting an encrypted version of the raw image from the local vision sensor to the server.

6. The computer-implemented method of claim 1, wherein the second fall detection model includes a large vision-language model (VLM) configured to detect a fall of the detected person by processing the received raw image.

7. The computer-implemented method of claim 6, wherein prior to processing the raw image using the second fall detection model, the method further comprises training the large VLM using a training dataset constructed to accommodate as many types of true fall scenarios as possible.

8. The computer-implemented method of claim 6, wherein the server is a cloud-based server that includes significantly higher computational resources than those of the local vision sensor, and wherein the VLM has significantly higher accuracies in detecting various types of falls of the at least one monitored person than the accuracies of the first fall detection model.

9. The computer-implemented method of claim 1, wherein the method further comprises, in response to determining that a fall has occurred based on the raw image by the second fall detection model, sending a fall alert to a mobile device of the user indicating the at least one monitored person has fallen.

10. A system for automatically detecting personal falls through video monitoring on behalf of a user, comprising:
a local vision sensor that includes:
one or more cameras configured to capture a video of a monitored space including at least one monitored person;
a first set of processors; and
a first memory coupled to the one or more cameras and the first set of processors and storing instructions that, when executed by the first set of processors, cause the local vision sensor to:
process one or more video frames of the video using a first fall detection model to detect a fall of the at least one monitored person; and
in response to detecting a fall of the at least one monitored person, transmit a raw image of the monitored space and a fall alert to a server; and
the server that includes:
a second set of processors; and
a second memory coupled to the second set of processors and storing instructions that, when executed by the second set of processors, cause the server to:
receive the raw image of the monitored space and the associated fall alert from the local vision sensor;
process the raw image using a second fall detection model to detect a fall of the at least one monitored person;
in response to determining that no fall has occurred of the at least one monitored person,
identify the received fall alert from the local vision sensor as a false alarm; and
disregard the received fall alert, thereby reducing a number of false alarms; and
in response to determining that a fall has occurred of the at least one monitored person, send a fall alert to a mobile device of the user indicating the at least one monitored person has fallen.

11. The system of claim 10,
wherein the first fall detection model includes a first deep-learning model configured to detect a fall based on recognizing a set of predetermined human actions; and
wherein the first set of processors includes an embedded artificial intelligence (AI) processor for executing the deep-learning-based fall detection model, and wherein the embedded AI processor is associated with limited computational resources.

12. The system of claim 10, wherein the first memory further stores instructions that, when executed by the first set of processors, cause the local vision sensor to:
extract at least one skeleton-figure representation of the at least one monitored person, wherein the at least one skeleton-figure representation does not include personal identifiable information (PII) of the at least one monitored person; and
apply the first deep-learning model on the at least one skeleton-figure representation to detect a fall of the at least one monitored person.

13. The system of claim 10, wherein the first memory further stores instructions that, when executed by the first set of processors, cause the local vision sensor to:
obtain the raw image by capturing a real-time image of the monitored space; and
transmit an encrypted version of the raw image to the server.

14. The system of claim 10, wherein the second fall detection model includes a large vision-language model (VLM) configured to detect a fall of the detected person by processing the received raw image, and wherein prior to processing the raw image using the second fall detection model, the method further comprises training the large VLM using a training dataset constructed to accommodate as many types of true fall scenarios as possible.

15. The system of claim 14, wherein the server is a cloud-based server that includes significantly higher computational resources than those of the local vision sensor, and wherein the VLM has significantly higher accuracies in detecting various types of falls of the at least one monitored person than fall detection accuracies of the first fall detection model.

16. A computer-implemented method of detecting personal falls through video monitoring on behalf of a user, the method comprising:
at a local vision sensor,
capturing a video of a monitored space including at least one monitored person;
processing one or more video frames of the video using a first fall detection model to detect a fall of the at least one monitored person; and
in response to determining that no fall has occurred of the at least one monitored person,
determining if a set of predefined conditions is met; and
if so, transmitting a raw image of the monitored space and a non-fall decision to a server,
at the server,
receiving the raw image of the monitored space and the associated non-fall decision from the local vision sensor;
processing the raw image using a second fall detection model to detect a fall of the at least one monitored person; and
in response to detecting a fall of the at least one monitored person by the second fall detection model:
identifying the received non-fall decision from the local vision sensor as a missed fall detection; and
sending a fall alert to a mobile device of the user indicating the at least one monitored person has fallen, thereby mitigating the missed fall detection.

17. The computer-implemented method of claim 16, wherein the set of predefined conditions includes:
the at least one monitored person is detected at a location within a floor area of the monitored space;
the at least one monitored person has remained at the detected location for at least a predefined time threshold T; and
no fall alert has been sent by the local vision sensor from the detected location.

18. The computer-implemented method of claim 16, wherein the predefined time threshold T is determined to be the minimum time required to call the second fall detection model on the server to verify the non-fall decision by the local vision sensor.

19. The computer-implemented method of claim 16, wherein the predefined time threshold T is determined to be the maximum wait time before calling the second fall detection model on the server to verify a non-fall decision to ensure the safety of the at least one monitored person in case of a missed fall detection by the local vision sensor.

20. The computer-implemented method of claim 16, wherein in response to determining that the set of predefined conditions is not met, proceeding to executing other tasks without transmitting a raw image of the monitored space and a non-fall decision to the server, thereby reducing unnecessary calls to the second fall detection model on the server when non-fall decisions are made by the local vision sensor, which facilitates reducing computational costs.

21. The computer-implemented method of claim 17,
wherein the first fall detection model includes a first deep-learning model configured to detect a fall of the at least one detected person based on recognizing a set of predetermined human actions;
wherein the second fall detection model includes a large vision-language model (VLM) configured to detect a fall of the at least one detected person by processing the received raw image; and
wherein the VLM has significantly higher accuracies in detecting various types of falls of the at least one monitored person than fall detection accuracies of the first deep-learning model.

22. The computer-implemented method of claim 17,
wherein the local vision sensor includes an embedded artificial intelligence (AI) processor for executing the first deep-learning model, wherein the embedded AI processor is associated with limited computational resources; and
wherein the server is a cloud-based server that includes one or more graphic processing units (GPUs); and
wherein the cloud-based server includes significantly higher computational power and storage space than those of the local vision sensor.
